(19) United States
(12) Patent Application Publication
(10) Pub. No.: US 2013/0247883 A1
(43) Pub. Date: Sep. 26, 2013

(54) CONTROL DEVICE FOR INTERNAL COMBUSTION ENGINE

(71) Applicants: Tomomi Onishi, Susono-shi (JP); Teruhiko Miyake, Susono-shi (JP)

(72) Inventors: Tomomi Onishi, Susono-shi (JP); Teruhiko Miyake, Susono-shi (JP)

(73) Assignee: TOYOTA JIDOSHA KABUSHIKI KAISHA, Toyota-shi, Aichi (JP)

(21) Appl. No.: 13/992,135

(22) PCT Filed: Dec. 9, 2010
(86) PCT No.: PCT/JP2010/072085

§ 371 Date: Jun. 6, 2013

(51) Int. Cl. F02M 25/07

(52) U.S. Cl. CPC F02M 25/07
USPC 123/568.11

(57) ABSTRACT

A control device includes first means and second means for recirculating exhaust gas from an exhaust passage toward an intake passage. When first recirculated gas amount recirculated by first means for recirculating exhaust gas is changed to a target amount, the control device compensates for the difference of the first recirculated gas amount during a period from a start time of change to an end time of change by increasing or decreasing the second recirculated gas amount recirculated by second means for recirculating exhaust gas, according to a predetermined control pattern. When an actual amount of index related to the recirculated gas amount that is a constituent included in the exhaust gas and an amount of the constituent vary depending on total amount of the exhaust gas does not match a referential amount of the index, the control pattern is corrected to decrease the difference of the index that is a difference of the actual amount with reference to the referential amount.

### TECHNICAL FIELD

The present invention relates to a control device applied to an internal combustion engine that performs exhaust gas recirculation to flow back part of exhaust gas of the engine from an exhaust passage to an intake passage (so-called external-EGR, hereinafter simply referred to as “EGR”).

### BACKGROUND ART

Gases exhausted from internal combustion engines such as spark-ignited internal combustion engines and diesel engines include several substances, such as nitrogen oxide (NOx) and particle matters (PM), hereinafter referred to as “emission(s)”. It is desirable to decrease the amount of the emissions as much as possible. Examples of methods to decrease the amount of the emissions in the exhaust gas include a method to guide exhaust gas (EGR gas) recirculated from the exhaust passage to the intake passage into a combustion chamber together with flesh air so as to decrease the amount of NOx.

On the other hand, there is a trade-off relationship between the amount of NOx in the exhaust gas and the amount of PM in the exhaust gas, as is known in this technical field. That is, the amount of PM will increase when the internal combustion engine is controlled so as to decrease the amount of NOx (for example, when the amount of EGR gas in the above example is increased), or the amount of NOx will increase when the internal combustion engine is controlled so as to decrease the amount of PM (for example, when the amount of EGR gas in the above example is decreased). Therefore, it is desirable to control the internal combustion engine in consideration of both of the amount of NOx and the amount of PM from the viewpoint of the overall decrease of the amount of the emissions. For example, it is desirable to control the amount of EGR gas so that the amount of NOx is adjusted to match a predetermined target amount according to the abilities of catalysts for purifying the exhaust gas.

Therefore, one of conventional control devices for internal combustion engines (hereinafter referred to as “conventional device”) is applied to an internal combustion engine with superchargers including compressors and turbines, a passage to recirculate exhaust gas from an upstream side of the turbines to an downstream side of the compressors (high-pressure EGR passage), a control valve located on the high-pressure EGR passage, a passage to recirculate exhaust gas from an downstream side of the turbines to an upstream side of the compressors (low-pressure EGR passage), a control valve located on the low-pressure EGR passage, and plural oxygen concentration sensors. This conventional control device calculates the amount of exhaust gas passing through the high-pressure EGR passage (the amount of high-pressure EGR gas) and the amount of exhaust gas passing through the low-pressure EGR passage (the amount of low-pressure EGR gas) based on output values of the plural oxygen concentration sensors. Then, the conventional control device controls opening degree of each control valve so as to match the calculated amount of EGR gas to each target amount. By the above operation, the conventional control device controls the total amount of the recirculated EGR gas (that is, the amount of EGR gas). For example, see the patent literature 1.

### Citation List

Patent literature 1: JP 2008-261300 A

### SUMMARY OF INVENTION

### 1. Technical Problem

The conventional device calculates (presumes) the amounts of the high-pressure EGR gas and the low-pressure EGR gas on an assumption that “oxygen concentration of gas at a detecting position do not change during the period from a timing that target gas (exhaust gas or mixture gas of exhaust gas and flesh air) passes through the position where the oxygen concentration sensor is located (the detecting position) to a timing that the target gas is entered into the combustion chamber.” More specifically, it is supposed in the conventional control device that “when the gas passing through the detecting position at a first timing is entered into the combustion chamber at a second timing, which is later than the first timing, the oxygen concentration of the gas do not change during the first timing to the second timing.”

The above assumption can be reasonable if the change rate of the oxygen concentration at the detecting position is sufficiently small (for example, if steady-state where the change rate of load on the engine is sufficiently small is continued). There may be a case, however, that the oxygen concentration of the gas existing at the detecting position at the first timing and the oxygen concentration of the gas existing at the detecting position at the second timing do not necessarily match each other (that is, the oxygen concentration of the gas at the detecting position changes) if the change rate of the oxygen concentration at the detecting position is large (for example, in transient-state where the load of the engine increases or decreases). In this case, the amounts of the high-pressure EGR gas and the low-pressure EGR gas calculated based on the above assumption (calculated values) do not sufficiently match to the actual amounts of the high-pressure EGR gas and the low-pressure EGR gas (actual values).

As discussed above, the conventional device might not calculate the amounts of the high-pressure EGR gas and the low-pressure EGR gas appropriately when the operating state of the engine changes (for example, in the transient-state). In this case, the conventional device has a problem that the total amount of the recirculated exhaust gas (the amount of EGR gas) might not be controlled appropriately.

In view of the above technical problems, it is an object of the present invention to provide a control device for an internal combustion engine that can control the amount of EGR gas even when the operating state of the engine changes.

### 2. Solution to Problem

The control device of the present invention for solving the above technical problem is applied to an engine that has plural route to recirculate exhaust gas from an intake passage to an exhaust passage.

More specifically, the engine has,

“first means” for recirculating exhaust gas discharged from a combustion chamber of the engine to an exhaust passage toward an intake passage through first passage, and

“second means” for recirculating exhaust gas discharged from the combustion chamber to the exhaust passage toward the intake passage through second passage different from the first passage.

By the above configuration, the engine to which the control device of the invention is applied can recirculate exhaust gas from the intake passage to the exhaust passage by both of the first means and the second means.

In addition, the control device of the invention may have three or more means for recirculating exhaust gas. The first means and the second means may be any two of those three or more means, when the control device has three or more means for recirculating exhaust gas.

Furthermore, the phrase “recirculating exhaust gas from the exhaust passage toward the intake passage” represents that at least part of the exhaust gas discharged from the combustion chamber of the engine is recirculated, but does not necessarily represent that all of the exhaust gas is recirculated.

The control device of the invention, which is applied to the engine having the above configuration, comprises, control means for controlling recirculated gas amount, the control means controlling “first recirculated gas amount” and “second recirculated gas amount”, the first recirculated gas amount being an amount of exhaust gas recirculated by the first means and entered into the combustion chamber, the second recirculated gas amount being an amount of exhaust gas recirculated by the second means and entered into the combustion chamber.

Examples of the “first recirculated gas amount” and the “second recirculated gas amount” include an amount (such as mass or volume) of exhaust gas entered into the combustion chamber per unit time. Furthermore, examples of the “first recirculated gas amount” and the “second recirculated gas amount” include a ratio (EGR ratio) of exhaust gas entered into the combustion chamber with reference to the total amount of gas entered (an amount of mixture gas of flesh air and exhaust gas) into the combustion chamber. That is, the “first recirculated gas amount” may be an amount that represents a degree of the amount of the exhaust gas recirculated and entered into the combustion chamber by the first means, the “second recirculated gas amount” may be an amount that represents a degree of the amount of the exhaust gas recirculated and entered into the combustion chamber by the second means.

Control of the first recirculated gas amount and the second recirculated gas amount by the control means will be described below in the following order of the items 1 to 4:

1. Basic concept of controlling recirculated gas amount

2. Correction of control pattern

3. Response time of recirculated gas

4. Others

### 1. Basic Concept of Controlling Recirculated Gas Amount

The control means controls the second recirculated gas amount to compensate for “a difference of the first recirculated gas amount with reference to a target amount”, which may occur while the first recirculated gas amount is changed, by the second recirculated gas amount.

More specifically, the control means has a predetermined “control pattern” to increase or decrease the second recirculated gas amount to compensate for “a difference of the first recirculated gas amount with reference to a target amount”, and increases or decreases the second recirculated gas amount according to the control pattern during a period from “a start time of change” to “an end time of change”, the start time being a moment of the first recirculated gas amount being started to change toward the target amount, the end time being a moment of the first recirculated gas amount being reached to the target amount.

The term “target amount” may be set at an appropriate value depending on the operating state of the engine, etc. For example, as the target amount of the first recirculated gas amount, an amount to decrease the amount of discharged emission as far as possible (for example, an amount to match the NOx amount to a predetermined target amount). Furthermore, examples of the target amount of the first recirculated gas amount include an amount to match the total amount of the first recirculated gas amount and the second recirculated gas amount to a predetermined target total amount.

The exhaust gas needs a predetermined length of time to move (to be recirculated from the intake passage to the exhaust passage) because the exhaust gas of engines has a predetermined composition, density, and viscosity. Therefore, the period where the first recirculated gas amount (actual value) and the target amount do not match each other (that is, the period from the start time to the end time) may be occur.

Therefore, the control means compensates for the difference between the first recirculated gas amount and the target amount (that is, the above difference) by increases or decreases the second recirculated gas amount. More specifically, the control means has a predetermined “control pattern to increase or decrease the second recirculated gas amount”, and increases or decreases the second recirculated gas amount according to the control pattern. For example, the control means increases the second recirculated gas amount when the actual value of the first recirculated gas amount is smaller than the target amount (that is, the difference is a negative value), and decreases the second recirculated gas amount when the actual value of the first recirculated gas amount is larger than the target amount (that is, the difference is a positive value).

The “control pattern” may be “a rule to be a basis for determining a degree of the increase or the decrease of the second recirculated gas amount to compensate for the difference”, and is not specifically limited. Furthermore, methods to “predetermine” the control pattern are not specifically limited.

Examples of the control pattern include “models (maps)” determined in advance in consideration of configurations of the engine and characteristics of the exhaust gas. Examples of such models include models that can derive a “relationship between the degree of the increase or the decrease of the second recirculated gas amount and time” from predetermined operation parameters.

Furthermore, examples of the “relationship between the degree of the increase or the decrease of the second recirculated gas amount and time” include the following items: a “profile that represents the degree of the increase or the decrease of the second recirculated gas amount with reference to time from the start time”; a “function whose input is a length of time from the start time and whose output is the degree of the increase or the decrease of the second recirculated gas amount”; and a “combination between the target amount of the degree of the increase or the decrease of the second recirculated gas amount and a length of time to match the degree of the increase or the decrease of the second recirculated gas amount to the target amount”. In addition, the “relationship between the degree of the increase or the decrease of the second recirculated gas amount and time” may include that the degree of the increase or the decrease is zero at a moment where the difference of the first recirculated gas amount is zero.

To increase or decrease the second recirculated gas amount based on the “degree of the increase or the decrease” derived from the “control pattern” in this invention is referred to as “to increase or decrease the second recirculated gas amount according to the control pattern” or “to compensate for the difference of the first recirculated gas amount according to the control pattern”.

As described above, both of the first means and the second means can recirculate the exhaust gas from the exhaust passage to the intake passage. Therefore, the control device can make the total amount of the first recirculated gas amount and the second recirculated gas amount closer to the total amount obtained when the first recirculated gas amount matches to the target amount than the total amount obtained when the second recirculated gas amount is not increased or decreased, by increasing or decreasing the second recirculated gas amount according to the control pattern during the period from the start time of change to the end time of change.

The control device of the invention can control the total amount of the first recirculated gas amount and the second recirculated gas amount (that is, the EGR gas amount) appropriately even during the period of changing the first recirculated gas amount, as described above. Thereby, the control device of the invention can control the EGR gas amount appropriately even when the operating state of the engine is changed (for example, in the transient state). The above is the basic concept of controlling the recirculated gas amount.

### 2. Correction of Control Pattern

As described above, the control pattern used in the control means for controlling recirculated gas amount is determined in advance so as to compensate for the difference of the first recirculated gas amount, which may occur during the change of the first recirculated gas amount.

It is thought, however, that the difference of the first recirculated gas amount may be not always sufficiently compensated, depending on the operating state of the engine, by increasing or decreasing the second recirculated gas amount according to the “predetermined” parameter. For example, the difference of the first recirculated gas amount may be affected by the length of flow path through which the exhaust gas recirculated by the first means flows. However, each member related to the length of the flow path (for example, members that constitutes the first passage) may have structural variations (that is, differences may occur in size or performance between the same members when the members are produced). Furthermore, the length of the flow path may vary due to aging degradation of the members. Accordingly, the difference of the first recirculated gas amount may be not always sufficiently compensated by increasing or decreasing the second recirculated gas amount according to the predetermined parameter.

Therefore, the “predetermined control pattern” is corrected as necessary in the control device of the invention. More specifically, the control pattern is configured to be corrected to decrease a “difference of index related to the recirculated gas amount”, upon an actual amount of the index not matching a referential amount thereof while the second recirculated gas amount being increased or decreased according to the control pattern during the period from the start time to the end time, the index being “a constituent included in the exhaust gas discharged from a combustion chamber to the exhaust passage, and an amount of the constituent varying depending on total amount of the exhaust gas recirculated by the first means and the second means and entered into the combustion chamber”, the difference of the index being a difference of the actual amount with reference to the referential amount.

The “referential amount” of the index related to the recirculated gas amount corresponds to “the amount of the index when the difference of the first recirculated gas amount is sufficiently compensated by the second recirculated gas amount (that is, when the difference is zero, or when the difference is an amount around zero and can be substantially assumed to be zero in the viewpoint of controlling the recirculated gas amount)”. In other words, the index becomes “zero, or an amount that is around zero and can be substantially assumed to be zero in the viewpoint of controlling the recirculated gas amount” when the difference of the first recirculated gas amount is sufficiently compensated by the second recirculated gas amount.

The phrase “to decrease the difference of index” represents that the difference of the index when the second recirculated gas amount is increased or decreased by the control pattern “after” the correction becomes a value closer to zero than the difference of the index when the second recirculated gas amount is increased or decreased by the control pattern “before” the correction. In other words, the phrase “to decrease the difference of index” represents that the absolute value of the difference of the index becomes smaller. In addition, the phrase “the difference of the index becomes smaller” includes the difference of the index becomes zero.

It is understandable by the above description that the difference of the index is zero when the total amount (the sum of the first recirculated gas amount, and the second recirculated gas amount that is increased or decreased) is “the amount where the amount of the index becomes the referential amount”. On the other hand, the difference of the index is a value different from zero (that is, a positive value or a negative value) when the total amount does not match to “the amount where the amount of the index becomes the referential amount”. Therefore, the value of the difference of the index can be an indicator to determine whether or not the amount of the increase or the decrease of the second recirculated gas amount (that is, the control pattern) is appropriate.

Therefore, the control pattern after the correction can compensate for the difference of the first recirculated gas amount more appropriately than the control pattern before the correction, when the control pattern is corrected so that the difference of the index becomes smaller. As described above, the control device of the invention can control the EGR gas amount more appropriately by correcting the predetermined control pattern (for example, so as to match individual engine) as necessary.

Specific methods for the correction of the control pattern will be described below.

In first embodiment of the control device of the invention,

the control pattern may be corrected based on “whether the difference of the index during the period from the start time to the end time being zero, positive value, and negative value”.

More specifically, in second embodiment of the control device of the invention,

the control pattern may be corrected in the following manner (A) and (B), when the index is a constituent having an amount “decreasing” with “increasing” total amount of the exhaust gas recirculated by the first means and the second means and entered into the combustion chamber.

(A) In the case that the target amount of the first recirculated gas amount is changed and the first recirculated gas amount is “increased” toward the target amount:

The control pattern may be corrected to “increase an increased amount” of the second recirculated gas amount at a moment of occurrence of the difference of the index of a positive value or a moment just before the occurrence thereof, upon the difference of the index is the “positive value”. On the other hand, the control pattern may be corrected to “decrease an increased amount” of the second recirculated gas amount at a moment of occurrence of the difference of the index of a negative value or a moment just before the occurrence thereof, upon the difference of the index is the “negative value”.

(B) In the case that the target amount of the first recirculated gas amount is changed and the first recirculated gas amount is “decreased” toward the target amount:

The control pattern may be corrected to “decrease a decreased amount” of the second recirculated gas amount at a moment of occurrence of the difference of the index of a positive value or a moment just before the occurrence thereof, upon the difference of the index is the “positive value”. On the other hand, the control pattern may be corrected to “increase a decreased amount” of the second recirculated gas amount at a moment of occurrence of the difference of the index of a negative value or a moment just before the occurrence thereof, upon the difference of the index is the “negative value”.

The “increased amount of the second recirculated gas amount” represents, when the second recirculated gas amount is increased by a predetermined amount, an absolute value of the predetermined amount. Furthermore, the “decreased amount of the second recirculated gas amount” represents, when the second recirculated gas amount is decreased by a predetermined amount, an absolute value of the predetermined amount.

Reasons for the corrections of the control pattern as the above (A) and (B) in this embodiment will be described below.

As described above, a predetermined length of time is required to reach the actual amount of the first recirculated gas amount to the target amount when the first recirculated gas amount “increases” toward the target amount. Therefore, the first recirculated gas amount is smaller than the target amount during the period from the start time to the end time in this case. That is, the first recirculated gas amount in this period is not sufficient with reference to the target amount. Therefore, the control pattern in this case is determined in advance to “increase the second recirculated gas amount” to compensate for the shortage of the first recirculated gas amount (for example, see FIG. 4). In addition, the “shortage” represents the absolute value of the shortage of the first recirculated gas amount.

However, the “increased amount of the second recirculated gas amount” determined by the control pattern does not always match to the shortage of the first recirculated gas amount sufficiently due to the structural variations of the members constituting the engine, as described above. The difference of the index occurs in this case.

For example, the total amount becomes “smaller” than the total amount obtained when the increased amount of the second recirculated gas amount matches to the shortage of the first recirculated gas amount, when the increased amount of the second recirculated gas amount is “smaller” than the shortage of the first recirculated gas amount. The amount of the index in this case becomes “larger” than the referential amount, since the index is a constituent having an amount decreasing with increasing total amount. That is, the difference of the index of a “positive value” occurs in this case.

Therefore, the control pattern is corrected “to increase an increased amount” of the second recirculated gas amount at a moment of occurrence of the difference of the index or a moment just before the occurrence thereof (the former clause of the above A).

On the other hand, the total amount becomes “larger” than the total amount obtained when the increased amount of the second recirculated gas amount matches to the shortage of the first recirculated gas amount, when the increased amount of the second recirculated gas amount is “larger” than the shortage of the first recirculated gas amount. Therefore, the amount of the index in this case becomes “smaller” than the referential amount. That is, the difference of the index of a “negative value” occurs in this case.

Therefore, the control pattern is corrected “to decrease an increased amount” of the second recirculated gas amount at a moment of occurrence of the difference of the index or a moment just before the occurrence thereof (the latter clause of the above A).

To the contrary, a predetermined length of time is required to reach the actual amount of the first recirculated gas amount to the target amount when the first recirculated gas amount “decreases” toward the target amount. The first recirculated gas amount is larger than the target amount during the period from the start time to the end time in this case. That is, the first recirculated gas amount in this period is excessive with reference to the target amount. Therefore, the control pattern in this case is determined to “decrease the second recirculated gas amount” to compensate for the excess of the first recirculated gas amount (for example, see FIG. 6). In addition, the “excess” represents the absolute value of the excess of the first recirculated gas amount.

However, the “decreased amount of the second recirculated gas amount” determined by the control pattern does not always match to the shortage of the first recirculated gas amount sufficiently due to the same reason described above. The difference of the index occurs in this case.

For example, the total amount becomes “smaller” than the total amount obtained when the increased amount of the second recirculated gas amount matches to the excess of the first recirculated gas amount, when the increased amount of the second recirculated gas amount is “larger” than the excess of the first recirculated gas amount. The amount of the index in this case becomes “larger” than the referential amount, since the index is a constituent having an amount decreasing with increasing total amount. That is, the difference of the index of a “positive value” occurs in this case.

Therefore, the control pattern is corrected “to decrease a decreased amount” of the second recirculated gas amount at a moment of occurrence of the difference of the index or a moment just before the occurrence thereof (the former clause of the above B).

On the other hand, the total amount becomes “larger” than the total amount obtained when the increased amount of the second recirculated gas amount matches to the excess of the first recirculated gas amount, when the increased amount of the second recirculated gas amount is “smaller” than the excess of the first recirculated gas amount. The amount of the index in this case becomes “smaller” than the referential amount. That is, the difference of the index of a “negative value” occurs in this case.

Therefore, the control pattern is corrected “to increase a decreased amount” of the second recirculated gas amount at a moment of occurrence of the difference of the index or a moment just before the occurrence thereof (the latter clause of the above B).

The difference of the index is decreased by correcting the control pattern as described above. That is, the amount of the index is made to be closer to the referential amount. The amount of the EGR gas is controlled more appropriately when the difference is compensated according to the control pattern that is corrected as above. These are reasons for the corrections of the control pattern as the above (A) and (B) in this embodiment will be described below.

By the way, when the control pattern is corrected to “increase an increased amount of the second recirculated gas amount at a moment ‘just before’ the occurrence of the difference of the index” (part of the former clause of the above (A)), the timing where the second recirculated gas amount is increased by the control pattern “after” the correction becomes “earlier” than the timing where the second recirculated gas amount is increased by the control pattern “before” the correction. That is, the correction of the control pattern as above corresponds to “make the timing where the second recirculated gas amount is increased” earlier.

As same as the above, when the control pattern is corrected to “decrease a decreased amount of the second recirculated gas amount at a moment ‘just before’ the occurrence of the difference of the index” (part of the former clause of the above (B)), the timing where the second recirculated gas amount is decreased by the control pattern “after” the correction becomes “earlier” than the timing where the second recirculated gas amount is decreased by the control pattern “before” the correction. That is, the correction of the control pattern as above corresponds to “make the timing where the second recirculated gas amount is decreased” earlier.

To the contrary, when the control pattern is corrected to “decrease an increased amount of the second recirculated gas amount at a moment ‘just before’ the occurrence of the difference of the index” (part of the latter clause of the above (A)), the timing where the second recirculated gas amount is increased by the control pattern “after” the correction becomes “delayed” than the timing where the second recirculated gas amount is increased by the control pattern “before” the correction. That is, the correction of the control pattern as above corresponds to “make the timing where the second recirculated gas amount is increased” delayed.

As same as the above, when the control pattern is corrected to “increase a decreased amount of the second recirculated gas amount at a moment ‘just before’ the occurrence of the difference of the index” (part of the latter clause of the above (B)), the timing where the second recirculated gas amount is decreased by the control pattern “after” the correction becomes “delayed” than the timing where the second recirculated gas amount is decreased by the control pattern “before” the correction. That is, the correction of the control pattern as above corresponds to “make the timing where the second recirculated gas amount is decreased” delayed.

As described above, the correction of the control pattern to “control a decreased amount or an increased amount of the second recirculated gas amount at a moment ‘just before’ the occurrence of the difference of the index” corresponds to “control a timing where the second recirculated gas amount is decreased or increased”. Therefore, the third embodiment of the invention will be described below from the viewpoint of controlling this timing.

In the third embodiment of the invention,

The control pattern may be corrected in the following manner (C) and (D), when the index is a “constituent having an amount decreasing with increasing total amount of the exhaust gas”.

(C) In the case that the target amount of the first recirculated gas amount is changed and the first recirculated gas amount is “increased” toward the target amount:

The control pattern may be corrected to “make a start of increasing the second recirculated gas amount earlier”, upon the difference of the index at “first timing” around the start time being the “positive value” and the difference of the index at “second timing” around the end time being the “negative value”. On the other hand, the control pattern may be corrected to “make a start of increasing the second recirculated gas amount delayed”, upon the difference of the index at the first timing being the “negative value” and the difference of the index at the second timing being the “positive value”.

(D) In the case that the target amount of the first recirculated gas amount is changed and the first recirculated gas amount is “decreased” toward the target amount:

The control pattern may be corrected to “make a start of decreasing the second recirculated gas amount delayed”, upon the difference of the index at the first timing being the “positive value” and the difference of the index at the second timing being the “negative value”. On the other hand, the control pattern may be corrected to “make a start of decreasing the second recirculated gas amount earlier”, upon the difference of the index at the first timing being the “negative value” and the difference of the index at the second timing being the “positive value”.

Reasons for the corrections of the control pattern as the above (C) and (D) in this embodiment will be described below.

As described in the above (A), the first recirculated gas amount is not sufficient at the start time, and the shortage of the first recirculated gas amount becomes zero at the end time, when the first recirculated gas amount “increases” toward the target amount. Therefore, the control pattern in this case is determined in advance to “start to increase the second recirculated gas amount at the start time and the increased amount of the second recirculated gas amount becomes zero at the end time”.

However, the “timing to start increasing the second recirculated gas amount” determined by the control pattern does not always match to the start time of change due to the structural variations of the members constituting the engine, as described above. The difference of the index occurs in this case.

For example, the total amount at a moment around the start time (the first timing) becomes “smaller” than the total amount obtained when the timing to start increasing the second recirculated gas amount matches to the start time, when the timing to start increasing the second recirculated gas amount is “later” than the start time. Furthermore, the total amount at a moment around the end time (the second timing) becomes “larger” than the total amount obtained when the timing to start increasing the second recirculated gas amount matches to the start time in this case, since the timing to “finish” increasing the second recirculated gas amount is delayed for the delay of the timing to “start” increasing the second recirculated gas amount (for example, see FIG. 11).

The amount of the index at the first timing in this case becomes “larger” than the referential amount, and the amount of the index at the second timing in this case becomes “smaller” than the referential amount, since the index is a constituent having an amount decreasing with increasing total amount. That is, the difference of the index of a “positive value” occurs at the first timing, and the difference of the index of a “negative value” occurs at the second timing, in the above case.

Therefore, the control pattern is corrected “to make a start of increasing the second recirculated gas amount earlier” (the former clause of the above C).

On the other hand, for example, the total amount at the first timing becomes “larger” than the total amount obtained when the timing to start increasing the second recirculated gas amount matches to the start time, when the timing to start increasing the second recirculated gas amount is “earlier” than the start time. Furthermore, the total amount at the second timing becomes “smaller” than the total amount obtained when the timing to start increasing the second recirculated gas amount matches to the start time, since the timing to finish increasing the second recirculated gas amount is earlier for the advance of the timing to start increasing the second recirculated gas amount.

Therefore, the amount of the index at the first timing in this case becomes “smaller” than the referential amount, and the amount of the index at the second timing in this case becomes “larger” than the referential amount. That is, the difference of the index of a “negative value” occurs at the first timing, and the difference of the index of a “positive value” occurs at the second timing, in the above case.

Therefore, the control pattern is corrected “to make a start of increasing the second recirculated gas amount delayed” (the latter clause of the above C).

To the contrary, as described in the above (B), the first recirculated gas amount is excessive at the start time, and the excess of the first recirculated gas amount becomes zero at the end time, when the first recirculated gas amount “decreases” toward the target amount. Therefore, the control pattern in this case is determined in advance to “start to decrease the second recirculated gas amount at the start time and the decreased amount of the second recirculated gas amount becomes zero at the end time”.

However, the “timing to start decreasing the second recirculated gas amount” determined by the control pattern does not always match to the start time of change due to the same reason as described above. The difference of the index occurs in this case.

For example, the total amount at the first timing becomes “smaller” than the total amount obtained when the timing to start decreasing the second recirculated gas amount matches to the start time, when the timing to start decreasing the second recirculated gas amount is “earlier” than the start time. Furthermore, the total amount at the second timing becomes “larger” than the total amount obtained when the timing to start decreasing the second recirculated gas amount matches to the start time, since the timing to finish decreasing the second recirculated gas amount is earlier for the advance of the timing to start decreasing the second recirculated gas amount.

The amount of the index at the first timing in this case becomes “larger” than the referential amount, and the amount of the index at the second timing in this case becomes “smaller” than the referential amount, since the index is a constituent having an amount decreasing with increasing total amount as described above. That is, the difference of the index of a “positive value” occurs at the first timing, and the difference of the index of a “negative value” occurs at the second timing, in the above case.

Therefore, the control pattern is corrected “to make a start of decreasing the second recirculated gas amount delayed” (the former clause of the above D).

On the other hand, for example, the total amount at the first timing becomes “larger” than the total amount obtained when the timing to start decreasing the second recirculated gas amount matches to the start time, when the timing to start decreasing the second recirculated gas amount is “later” than the start time. Furthermore, the total amount at the second timing becomes “smaller” than the total amount obtained when the timing to start decreasing the second recirculated gas amount matches to the start time, since the timing to finish decreasing the second recirculated gas amount is delayed for the delay of the timing to start decreasing the second recirculated gas amount (for example, see FIG. 12).

Therefore, the amount of the index at the first timing in this case becomes “smaller” than the referential amount, and the amount of the index at the second timing in this case becomes “larger” than the referential amount. That is, the difference of the index of a “negative value” occurs at the first timing, and the difference of the index of a “positive value” occurs at the second timing, in the above case.

Therefore, the control pattern is corrected “to make a start of decreasing the second recirculated gas amount earlier” (the latter clause of the above D).

The difference of the index is decreased by correcting the control pattern as described above. That is, the amount of the index is made to be closer to the referential amount. The amount of the EGR gas is controlled more appropriately when the difference is compensated according to the control pattern that is corrected as above. These are reasons for the corrections of the control pattern as the above (C) and (D) in this embodiment will be described below.

By the way, the “constituent having an amount ‘decreasing’ with increasing total amount of the exhaust gas entered into the combustion chamber” is employed as the index, in the correction methods of the control pattern of the above (A) to the above (D) (the second embodiment and the third embodiment). To the contrary, in the invention, a “constituent having an amount ‘increasing’ with increasing total amount of the exhaust gas entered into the combustion chamber” may be employed as the index. It is understandable by the above description that the control pattern may be corrected as the combination of the following (A′) and the following (B′) or the combination of the following (C′) and the following (D′), when the constituent is employed.

(A′) In the case that the target amount of the first recirculated gas amount is changed and the first recirculated gas amount is “increased” toward the target amount:

The control pattern may be corrected to “decrease an increased amount” of the second recirculated gas amount at a moment of occurrence of the difference of the index of a positive value or a moment just before the occurrence thereof, upon the difference of the index is the “positive value”. On the other hand, the control pattern may be corrected to “increase an increased amount” of the second recirculated gas amount at a moment of occurrence of the difference of the index of a negative value or a moment just before the occurrence thereof, upon the difference of the index is the “negative value”.

(B′) In the case that the target amount of the first recirculated gas amount is changed and the first recirculated gas amount is “decreased” toward the target amount:

The control pattern may be corrected to “increase a decreased amount” of the second recirculated gas amount at a moment of occurrence of the difference of the index of a positive value or a moment just before the occurrence thereof, upon the difference of the index is the “positive value”. On the other hand, the control pattern may be corrected to “decrease a decreased amount” of the second recirculated gas amount at a moment of occurrence of the difference of the index of a negative value or a moment just before the occurrence thereof, upon the difference of the index is the “negative value”.

(C′) In the case that the target amount of the first recirculated gas amount is changed and the first recirculated gas amount is “increased” toward the target amount:

The control pattern may be corrected to “make a start of increasing the second recirculated gas amount delayed”, upon the difference of the index at “first timing” around the start time being the “positive value” and the difference of the index at “second timing” around the end time being the “negative value”. On the other hand, the control pattern may be corrected to “make a start of increasing the second recirculated gas amount earlier”, upon the difference of the index at the first timing being the “negative value” and the difference of the index at the second timing being the “positive value”.

(D′) In the case that the target amount of the first recirculated gas amount is changed and the first recirculated gas amount is “decreased” toward the target amount:

The control pattern may be corrected to “make a start of decreasing the second recirculated gas amount earlier”, upon the difference of the index at the first timing being the “positive value” and the difference of the index at the second timing being the “negative value”. On the other hand, the control pattern may be corrected to “make a start of decreasing the second recirculated gas amount delayed”, upon the difference of the index at the first timing being the “negative value” and the difference of the index at the second timing being the “positive value”.

### 3. Response Time of Recirculated Gas

As described above, the control device of this invention compensates for the difference (shortage or excess) of the first recirculated gas amount by increasing or decreasing the second recirculated gas amount.

It is preferable that,

“first response time” that is a length of time required from a moment of starting the change of the first recirculated gas amount to a moment of entering the exhaust gas having the changed first recirculated gas amount into the combustion chamber, and

“second response time” that is a length of time required from a moment of starting the change of the second recirculated gas amount to a moment of entering the exhaust gas having the changed second recirculated gas amount into the combustion chamber,

satisfy the relationship that the second response time is shorter than the first response time.

The “first response time” and the “second response time” can be determined depending on following examples: the difference between the pressure of gas in the exhaust passage and the pressure of gas in the intake air passage; the length of flow path through which exhaust gas recirculated by the first means for recirculating exhaust gas flows; the length of flow path through which exhaust gas recirculated by the second means for recirculating exhaust gas flows; pressure losses caused in the flow paths; and cross-section areas of the first passage and the second passage.

In addition, the difference of the first recirculated gas amount is at least partly compensated even when the second response time is not shorter than the first response time. That is, the control means can decrease the difference of the first recirculated gas amount compared with “the difference when the second recirculated gas amount is not compensated”.

By the way, it is thought that the smaller “the difference between the actual amount of the first recirculated gas amount at the start time and the target amount of the first recirculated gas amount”, the shorter the first response time. That is, the smaller the difference, the shorter the length of the period in which the first recirculated gas amount does not match the target amount. Therefore, the difference of the first recirculated gas amount may be substantially assumed to be zero even when the control means does not increase or decrease the second recirculated gas amount, if the length of the period sufficiently short.

Therefore, in the invention,

the control means may be configured to increase or decrease the second recirculated gas amount according to the control pattern, “only” upon the difference between the actual amount of the first recirculated gas amount at the start time and the target amount of the first recirculated gas amount is larger than a predetermined threshold value.

### 4. Others

Specific methods to control the first recirculated gas amount and the second recirculated gas amount are not specifically limited in the invention. For example, the first means may be configured to have a first control valve to change an amount of exhaust gas passing through the first passage. Furthermore, the second means may be configured to have a second control valve to change an amount of exhaust gas passing through the second passage.

For example, the first recirculated gas amount is controlled (for example, changed toward the target amount) by giving an instruction to the first control valve so as to change the opening degree of the first control valve, in the above configuration. Furthermore, for example, the second recirculated gas amount is controlled (for example, increased or decreased) by giving an instruction to the second control valve so as to change the opening degree of the second control valve.

By the way, the control pattern is corrected based on the amount of the index related to the recirculated gas amount in the control device of the invention, as described above. The index may be a constituent having an amount “decreasing” with increasing total amount or a constituent having an amount “increasing” with increasing total amount, as the above embodiments.

For example, at least one of “nitrogen oxide” and “oxygen” included in the exhaust gas discharged from the combustion chamber may be employed as the index.

The amount of nitrogen oxide (NOx) decreases with increasing amount of the total amount because of the decrease of the combustion temperature of the mixture gas, etc. Furthermore, the amount of oxide decreases with increasing amount of the total amount because of the decrease of the flesh air entered into the combustion chamber. The nitrogen oxide and the oxide are constituents whose amounts “decrease” with increasing amount of the total amount.

Furthermore, for example, “total hydrocarbons (THC)” included in exhaust gas discharged from the combustion chamber may be employed as the index.

The amount of the total hydrocarbons included in exhaust gas increase with increasing amount of the total amount because of the decrease of the combustion temperature of the mixture gas and the increase of the amount of unburned fuel, etc. That is, the total hydrocarbons are constituents whose amount “increases” with increasing amount of the total amount.

### BRIEF DESCRIPTION OF DRAWINGS

FIG. 1 is a schematic diagram of an internal combustion engine that employs the control device according to the first embodiment of the invention.

FIG. 2 is a schematic flowchart that illustrates an operation of the control device according to the first embodiment of the invention.

FIG. 3 is a schematic diagram that illustrates a relationship between engine rotation speed, target amount of fuel injection amount, and EGR mode, employed in the control device according to the first embodiment of the invention.

FIG. 4 is a time chart that illustrates a relationship between EGR gas amount, compensation profile, NOx amount, and NOx amount difference, of the first embodiment of the invention.

FIG. 5 is a time chart that illustrates a relationship between EGR gas amount, compensation profile, NOx amount, and NOx amount difference, of the first embodiment of the invention.

FIG. 6 is a time chart that illustrates a relationship between EGR gas amount, compensation profile, NOx amount, and NOx amount difference, of the first embodiment of the invention.

FIG. 7 is a time chart that illustrates a relationship between EGR gas amount, compensation profile, NOx amount, and NOx amount difference, of the first embodiment of the invention.

FIG. 8 is a flowchart that illustrates a routine executed by the CPU on the control device according to the first embodiment of the invention.

FIG. 9 is a flowchart that illustrates a routine executed by the CPU on the control device according to the first embodiment of the invention.

FIG. 10 is a flowchart that illustrates a routine executed by the CPU on the control device according to the first embodiment of the invention.

FIG. 11 is a time chart that illustrates a relationship between EGR gas amount, compensation profile, NOx amount, and NOx amount difference, of the second embodiment of the invention.

FIG. 12 is a time chart that illustrates a relationship between EGR gas amount, compensation profile, NOx amount, and NOx amount difference, of the second embodiment of the invention.

FIG. 13 is a flowchart that illustrates a routine executed by the CPU on the control device according to the second embodiment of the invention.

### DESCRIPTION OF EMBODIMENTS

Hereinafter, each embodiment of the control device for internal combustion engines of the present invention will be described by referring to the drawings.

### First Embodiment

### <Outline of Device>

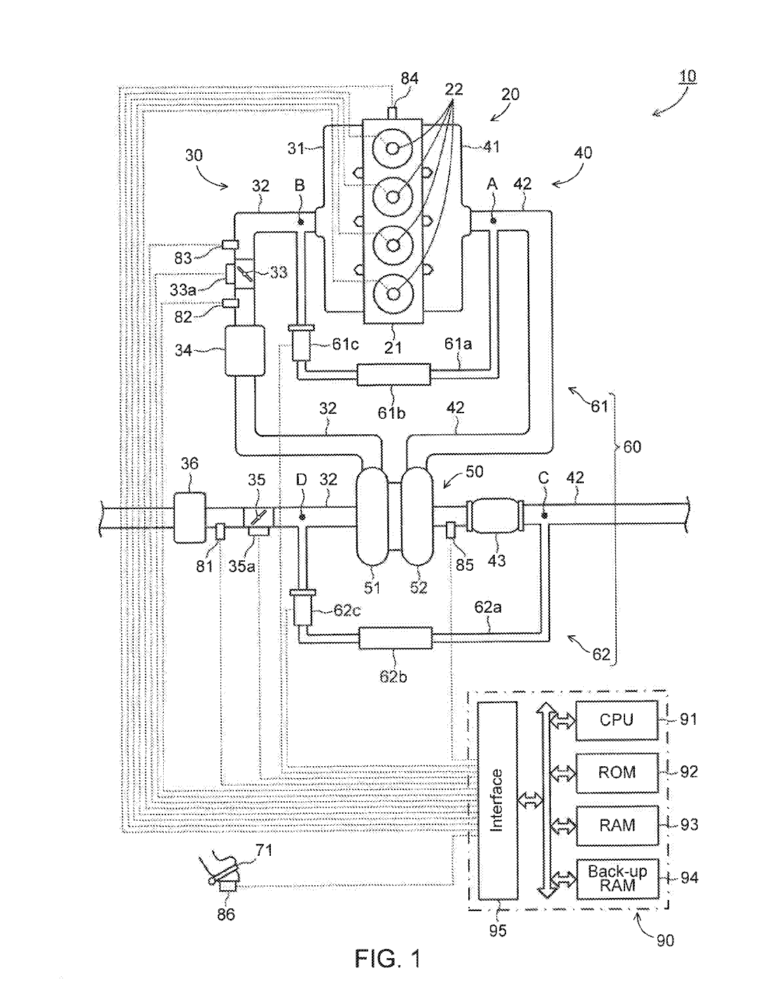

FIG. 1 illustrates a schematic configuration of a system where a control device according to the first embodiment of the present invention (hereinafter referred to as “first device”) is applied to internal combustion engine 10. The internal combustion engine 10 is a four-cylinder diesel engine that has four cylinders: first cylinder to fourth cylinder. Hereinafter, the “internal combustion engine 10” is simply referred to as “engine 10” for convenience.

As illustrated in FIG. 1, the engine 10 includes an engine body 20 having a fuel injection system, an intake system 30 to guide air into the engine body 20, an exhaust system 40 to discharge exhaust gas from the engine body 20 to the outside of the engine 10, a supercharging device 50 operated by the energy of the exhaust gas to compress air entered into the engine body 20, and an EGR device 60 to recirculate the exhaust gas from the exhaust system 40 to the intake system 30.

The engine body 20 includes a cylinder head 21 to which the intake system 30 and the exhaust system 40 are connected. The cylinder head 21 includes plural fuel injecting devices 22 (for example, solenoid-type injectors) that are respectively located on the upper portions of the respective cylinders so as to correspond to the respective cylinders. The respective fuel injecting devices 22 is connected to a fuel tank (not illustrated), and are configured to inject fuel into the combustion chambers of the respective cylinders depending on a command signal from an electric control device 90.

The intake system 30 includes intake ports (not illustrated) formed on the cylinder head 21, an intake manifold 31 that communicates with the respective cylinders through the intake ports, an intake pipe 32 that is connected to an assembled portion on the upstream side of the intake manifold 31, first throttle valve 33 located on the intake pipe 32 and can changes opening cross-sectional area in the intake pipe 32, a throttle valve actuator 33a that rotationally operates the first throttle valve 33 depending on a command signal from the electric control device 90, an intercooler 34 that is located in the intake pipe 32 on the upstream side of the throttle valve 33, a supercharging device 50 located on the upstream of the intercooler 34 (Note: Detail of this device is described below), second throttle valve 35 located on the upstream of the supercharging device 50 and can changes opening cross-sectional area in the intake pipe 32, a throttle valve actuator 35a that rotationally operates the second throttle valve 35 depending on a command signal from the electric control device 90, and an air cleaner 36 located on the end portion of the intake pipe 32 on the upstream of the second throttle valve 35. The intake manifold 31 and the intake pipe 32 constitute the intake passage.

The exhaust system 40 includes exhaust ports (not illustrated) formed on the cylinder head 21, an exhaust gas manifold 41 that communicates with the respective cylinders through the exhaust ports, an exhaust pipe 42 that is connected to an assembled portion on the downstream side of the exhaust gas manifold 41, a supercharging device 50 located on the exhaust pipe 42 (Note: Detail of this device is described below), and a catalyst 43 for purifying the exhaust gas (for example, the DPNR) located on the downstream of the supercharging device 50. The exhaust gas manifold 41 and the exhaust pipe 42 constitute the exhaust passage.

The supercharging device 50 includes a compressor 61 located on the intake passage (intake pipe 32) and a turbine 62 located in the exhaust passage (exhaust pipe 42). The compressor 61 and the turbine 62 are connected to each other by a rotor shaft (not illustrated) so as to be coaxially rotatable around the rotor shaft. Therefore, when the turbine 62 is rotated by the energy of the exhaust gas, the compressor 61 also rotates. Then, the air entered into the compressor 61 is compressed (that is, supercharging is performed) by using the energy of the exhaust gas.

The EGR device 60 includes a high-pressure EGR system 61, which is “first instrument” to recirculate exhaust gas from the exhaust system 40 (the exhaust passage) to the intake system 30 (intake passage), and a low-pressure EGR system 62, which is “second instrument” to recirculate exhaust gas in the same manner. The names of the “high-pressure EGR system” and the “low-pressure EGR system” are derived from the configuration where the pressure of exhaust gas recirculated by the “high-pressure” EGR system is higher than the pressure of exhaust gas recirculated by the “low-pressure” EGR system.

The high-pressure EGR system 61 includes high-pressure EGR passage 61 a whose one end is connected to the exhaust pipe 42 on the upstream of the turbine 52 (point A in the figure) and the other end is connected to the intake pipe 32 on the downstream of the compressor 51 (point B in the figure), a cooling device 61 b that is for the high-pressure EGR gas and is located on the high-pressure EGR passage 61a, and a high-pressure EGR control valve 61c that is located on the high-pressure EGR passage 61a and can change opening cross-sectional area in the high-pressure EGR passage 61a. The high-pressure EGR control valve 61c is configured to change the amounts of exhaust gas (the amount of the high-pressure EGR gas) that is recirculated from the exhaust passage to the intake passage through the high-pressure EGR passage 61a depending on a command signal from the electric control device 90.

The low-pressure EGR system 62 includes low-pressure EGR passage 62a whose one end is connected to the exhaust pipe 42 on the downstream of the turbine 52 (point C in the figure) and the other end is connected to the intake pipe 32 on the upstream of the compressor 51 (point D in the figure), a cooling device 62b that is for the low-pressure EGR gas and is located on the low-pressure EGR passage 62a, and a low-pressure EGR control valve 62c that is located on the low-pressure EGR passage 62a and can change opening cross-sectional area in the low-pressure EGR passage 62a. The low-pressure EGR control valve 62c is configured to change the amounts of exhaust gas (the amount of the low-pressure EGR gas) that is recirculated from the exhaust passage to the intake passage through the low-pressure EGR passage 62a depending on a command signal from the electric control device 90.

As described above, the high-pressure EGR system 61 is configured to recirculate exhaust gas through the exhaust gas passage (the high-pressure EGR passage 61a) that is different from the exhaust gas passage (the low-pressure EGR gas passage 62a) of the low-pressure EGR system 62. In other words, the engine 10 is configured to recirculate exhaust gas from the exhaust passage to the intake passage through the “both” of the high-pressure EGR system 61 and the low-pressure EGR system 62. In addition, of course, it is not necessary to recirculate exhaust gas from the exhaust passage to the intake passage by always the “both” of the high-pressure EGR system 61 and the low-pressure EGR system 62, but “only one” of the high-pressure EGR system 61 and the low-pressure EGR system 62 may recirculate exhaust gas from the exhaust passage to the intake passage depending on a command signal from an electric control device 90.

Furthermore, an accelerator pedal 71 to input a request to increase speed and a request torque, etc., is equipped on the outside of the engine 10. The accelerator pedal 71 is operated by operators of the engine 10.

Additionally, the first device includes plural sensors. More specifically, the first device has an intake air flow sensor 81, an intake air temperature sensor 82, a supercharging pressure sensor 83, a crank position sensor 84, oxygen concentration sensor 85, and an accelerator opening degree sensor 86.

The intake air flow sensor 81 is located on the intake pipe 32 on the upstream of the second throttle valve 35. The intake air flow sensor 81 is configured to output a signal depending on the amount of intake air that is the mass flow of air flowing through the intake pipe 32 (that is, the mass of air entered into the engine 10). The amount of intake air is obtained based on this signal.

The intake air temperature sensor 82 is located in the intake pipe 32 on the downstream of the intercooler 34. The intake air temperature sensor 82 is configured to output a signal depending on the temperature of the intake air flowing through the intake pipe 32. The intake air temperature is obtained based on this signal.

The supercharging pressure sensor 83 is located on the intake pipe 32 on the downstream of the compressor 51 and the downstream of the first throttle valve 33. The supercharging pressure sensor 83 is configured to output a signal representing the pressure of the air in the intake pipe 32 (that is, the pressure of air supplied into the combustion chamber. In other words, the supercharging pressure by the supercharging device 50). The supercharging pressure is obtained based on this signal.

The crank position sensor 84 is located near a crank shaft (not illustrated). The crank position sensor 84 is configured to output a signal having pulses relating to the rotation of the crankshaft. The number of rotations per unit time of the crankshaft (hereinafter simply referred to as “the engine rotation speed NE”) is obtained based on these signals.

The oxygen concentration sensor 85 is located in the exhaust pipe 42 on the upstream side of the catalyst 43. The oxygen concentration sensor 85 is a known demarcation-type oxygen concentration sensor. The oxygen concentration sensor 85 is configured to output a signal depending on oxygen concentration of the exhaust gas entered into the catalyst 43. The oxygen concentration of the exhaust gas (In other words, the air-fuel ratio) is obtained based on this signal.

The accelerator opening degree sensor 86 is located near the accelerator pedal 71. The accelerator opening degree sensor 86 is configured to output a signal depending on the opening degree of the accelerator pedal 71. The accelerator opening degree Accp is obtained based on this signal.

Furthermore, the first device includes an electric control device 90. The electric control device 90 includes a CPU 91, a ROM 92 that stores a program executed by the CPU 91, a table (map), a constant, and etc., in advance, a RAM 93 that temporarily stores data if necessary by the CPU 91, a back-up RAM 94 that stores data in power-on state and keeps the stored data even in power-off state, and an interface 95 that includes an AD converter, and etc. The CPU 91, the ROM 92, the RAM 93, the backup RAM 94 and the interface 95 are connected each other via a bus.

The interface 95 is connected to the respective sensors, etc., and configured to supply signals from the respective sensors, etc., to the CPU 91. Additionally, the interface 95 is connected to the fuel injecting device 22, each actuator 33a and 35a, the high-pressure EGR valve 61c and low-pressure EGR valve 62c, and output command signals to them.

### <Outline of Operation of Device>

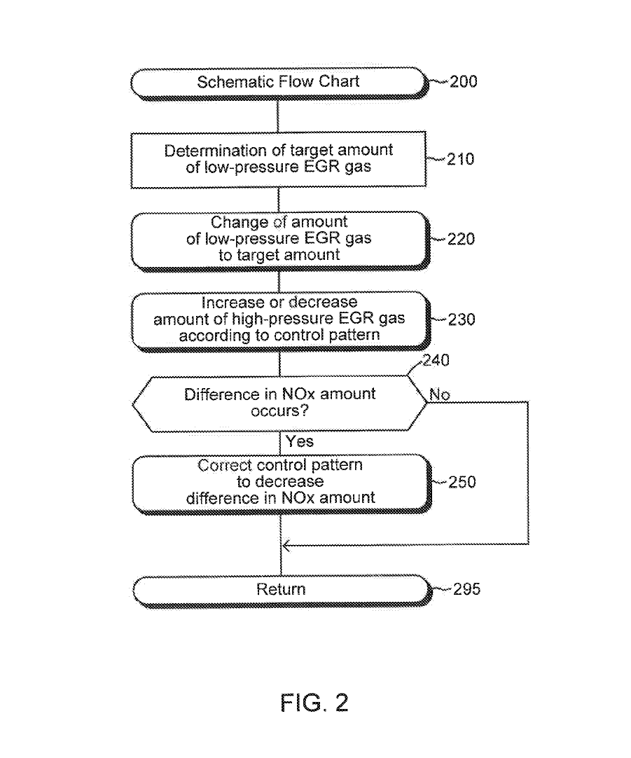

Hereinafter, the outline of the operation of the first device employed in the engine 10 will be described referring to FIG. 2. FIG. 2 is the “schematic flow chart” representing the outline of the operation of the first device.

The first device controls the amount of the high-pressure EGR gas so as to compensate for the “difference between the amount of the low-pressure EGR gas and a target amount thereof” that may occur while the amount of the low-pressure EGR gas is changed toward the target amount, by the amount of the high-pressure EGR gas.

More specifically, the first device determines the target amount of the low-pressure EGR gas at the step 210 of FIG. 2. This target amount is determined based on the operating state of the engine 10, etc. Next, the first device changes the amount of the low-pressure EGR gas to the target amount at the step 220. At the step 230, the first device determines “a degree of increase or decrease of the amount of the high-pressure EGR gas to compensate for the difference” (hereinafter referred to as “compensation profile”) based on predetermined control pattern, and changes the amount of the high-pressure EGR gas based on the compensation profile. In other words, the first device increases or decreases the amount of the high-pressure EGR gas according to the control pattern. By this process, the deviation of the amount of the low-pressure EGR gas is compensated.

Furthermore, the first device checks whether or not the difference is compensated appropriately and corrects the control pattern when the difference is not compensated appropriately.

More specifically, the first device records the “amount (actual amount) of NOx generated from the timing where the amount of the low-pressure EGR gas is started to change (hereinafter referred to as “start time of change”) to the timing where the amount of the low-pressure EGR gas reaches to the target amount (hereinafter referred to as “end time of change”).” Then, the first device confirms whether or not the recorded amount of NOx matches to predetermined reference amount. In other words, the first device determines whether or not the “difference in NOx amount”, which is the difference between the reference amount and the NOx amount, occurs.

The first device makes the “Yes” determination at step 240 when the difference in NOx amount occurs. Then, the first device corrects the control pattern to decrease the difference in NOx amount at the step 250. By this process, the control pattern is corrected so that the difference is compensated appropriately. On the other hand, the first device makes the “No” determination at the step 240 and does not correct the control pattern. These are the outline of the operation of the first device.

Hereinafter, the time period from the start time of change to the end time of change is referring to as “compensation time for EGR gas amount” for convenience. Furthermore, the high-pressure EGR gas and the low-pressure EGR gas are hereinafter simply referred to as “EGR gas amount” for convenience.

### <Determination Method for EGR Mode>

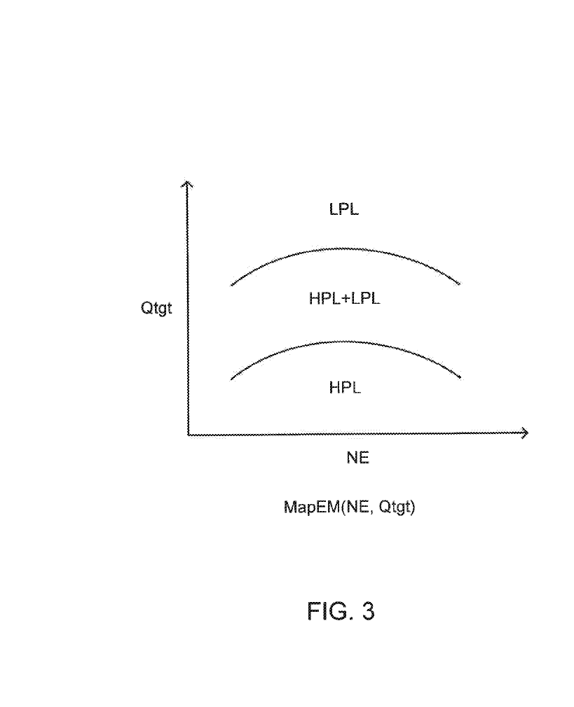

Next, operation modes of the EGR device 60 (hereinafter referred to as “EGR mode”) of the first device and method of determination thereof will be described referring to FIG. 3. FIG. 3 is a schematic diagram of map for determining the EGR mode.

The first device is configured to decide which of the high-pressure EGR system 61 and the low-pressure EGR system 62 to use based on the operating state of the engine 10. More specifically, the first device preferentially uses the high-pressure EGR system 61 when the load of the engine 10 is small. By this configuration, for example, ignition performance of fuel can be enhanced because of the recirculation of the exhaust gas having a large energy (exhaust gas before passing through the turbine 52). On the other hand, the first device preferentially uses the low-pressure EGR system 62 when the load of the engine 10 is large. By this configuration, for example, sufficient amount of the EGR gas can be recirculated by the low-pressure EGR system 62 even if the sufficient amount of EGR gas cannot be recirculated by the high-pressure EGR system 61 due to increase of supercharging pressure (pressure of gas on the downstream of the compressor 51). In addition, the first device uses the both of the high-pressure EGR system 61 and the low-pressure EGR system 62 when the load of the engine 10 is medium degree.

More specifically, the first device controls the amount of the high-pressure EGR gas by controlling the opening degrees of the first throttle valve 33 and the high-pressure EGR control valve 61 c based on the operating state of the engine 10. The first device also controls the amount of the low-pressure EGR gas by controlling the opening degrees of the second throttle valve 35 and the low-pressure EGR control valve 62c based on the operating state of the engine 10. That is, the first device operates the high-pressure EGR control valve 61c, the low-pressure EGR control valve 62c, the first throttle valve 33 and the second throttle valve 35 (hereinafter referred to as “each control valve”) so that an appropriate amount of exhaust gas is recirculated from the exhaust passage to the intake passage.

The first device divides the operating state of the engine 10 into three areas, and determines the rules of operation of each control valve so that the rules are each suitable for each of the three areas. The rules of operation are determined based on the EGR mode.

More specifically, the first device stores “EGR mode table MapEM(NE, Qtgt) that defines in advance the relationship between the engine rotation speed NE, the target amount Qtgt of fuel injection amount, and the EGR mode EM” illustrated in FIG. 3 in the ROM 92. The “HPL” represents a mode to preferentially operate the high-pressure EGR system 61 (HPL mode), The “HPL+LPL” represents a mode to operate both of the high-pressure EGR system 61 and the low-pressure EGR system 62 (MPL mode), and the “LPL” represents a mode to preferentially operate the low-pressure EGR system 62 (LPL mode).

The first device determines the EGR mode by applying actual engine rotation speed NE and target amount Qtgt of fuel injection amount to the EGR mode table MapEM(NE, Qtgt). Then, the first device operates the each control valve according to the determined EGR mode (that is, the opening degrees of the each control valve are controlled). These are the EGR mode of the first device and the methods for determining the EGR mode.

### <Control Method of EGR Gas Amount>

As described above, the first device compensates for the difference of the amount of the low-pressure EGR gas by increasing or decreasing the amount of the high-pressure EGR gas. The control methods of the amount of EGR gas (the amounts of the high-pressure EGR gas and the low-pressure EGR gas) will be described below for a case where the amount of the low-pressure EGR gas “increases” and a case where the amount of the low-pressure EGR gas “decreases.”

1. Case where the low-pressure EGR gas amount increases.

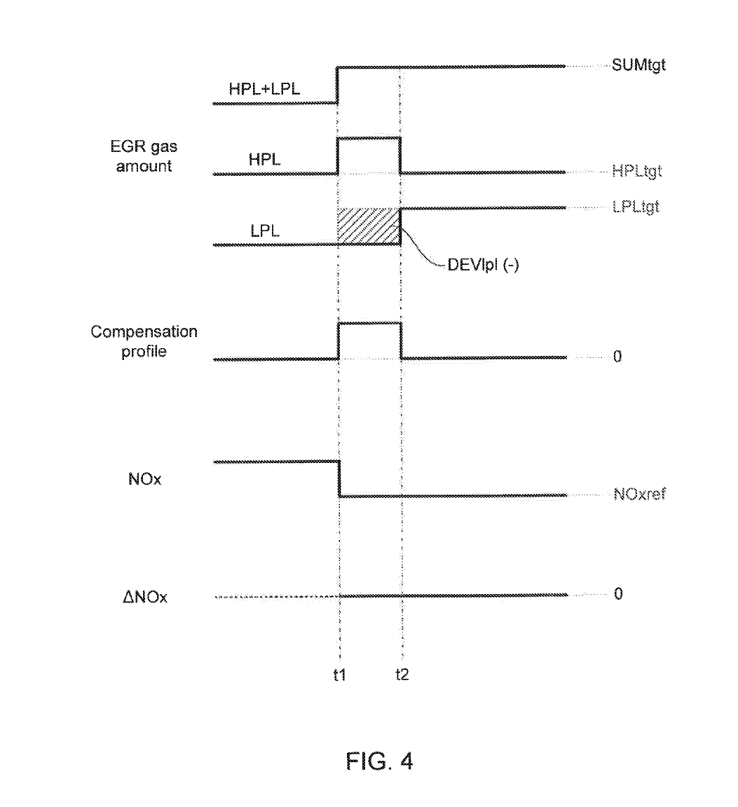

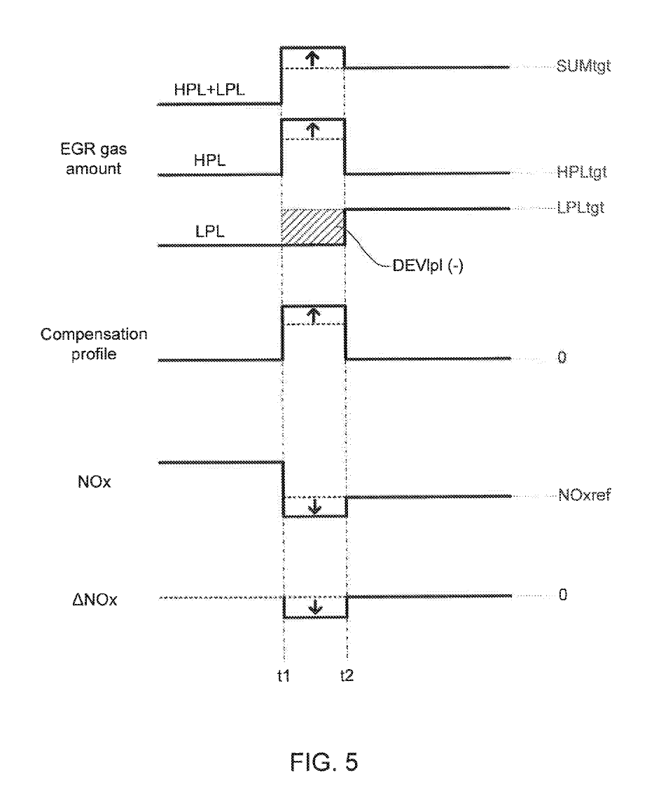

It will be described that the control method of the amount of the EGR gas in the case that the amount of the low-pressure EGR gas “increases” toward a predetermined target amount referring to the time charts illustrated in FIG. 4 and FIG. 5. FIG. 4 illustrates a time chart of an example where the increased or decreased amount of the amount of the high-pressure EGR gas to compensate for the difference is “an appropriate amount”, FIG. 5 illustrates a time chart of an example where the increased or decreased amount is “not” an appropriate amount. Each value in FIG. 4 and FIG. 5 is illustrated by simplifying each actual value for the sake of ease.

FIG. 4 is a time chart that illustrates the relationship between the EGR gas amount (the high-pressure EGR gas amount HPL, the low-pressure EGR gas amount LPL, and the total of them HPL+LPL), the compensation profile to increase or decrease the amount of the high-pressure EGR gas, the NOx amount included in exhaust gas, and the NOx amount difference ΔNOx that is the difference of the NOx amount with reference to a predetermined reference amount.

In this time chart, the operating state of the engine 10 changes at the timing t1, and the instruction to “increase the low-pressure EGR gas amount LPL toward a target amount LPLtgt” is given to the low-pressure EGR control valve 62c. It is assumed in FIG. 4 for the sake of ease that the high-pressure EGR gas amount HPL is not changed (that is, target amount HPLtgt is not increased or decreased) even when the operating state of the engine 10 is changed.

The exhaust gas (low-pressure EGR gas) after passing through the low-pressure EGR control valve 62c reaches to the combustion chamber via the point D in the figure, the compressor 51, the intercooler 34, the first throttle valve 33, the point B in the figure, and the intake manifold 31, in this order. Therefore, a predetermined time length is needed from the timing where the low-pressure EGR control valve 62c moves according to the instruction to the timing where the EGR gas of the low-pressure EGR gas amount LPL corresponding to the instruction reaches to the combustion chamber (that is, the start time of change to the end time of change). Accordingly, the low-pressure EGR gas amount LPL does not match to the target amount LPLtgt at the first timing t1 but matches to the target amount LPLtgt at the second timing t2, which is after the first timing t1.

By the way, it is thought that actual low-pressure EGR gas amount LPL does not instantly increases to the target amount LPLtgt at the second timing t2 due to operation time length of the low-pressure EGR control valve 62c, etc. That is, the low-pressure EGR gas amount LPL actually starts to increase at the second timing t2 toward the target amount LPLtgt and reaches to the target amount LPLtgt after a predetermined time length is passed from the second timing t2. In this example, however, it is assumed for the sake of ease that the low-pressure EGR gas amount LPL instantly increases to the target amount LPLtgt at the second timing t2. It is assumed in the same manner that “the time length is zero from a timing where a predetermined parameter stars to change to a timing where the change of the parameter is finished” in the following description.

As described above, the low-pressure EGR gas amount LPL does not match the target amount LPLtgt in the period from the first timing t1 to the second timing t2. As a result thereof, the difference is occurred between the target amount LPLtgt of the low-pressure EGR gas amount LPL and the low-pressure EGR gas amount LPL in this period. The difference is a negative value (in other words, shortfall) with reference to the target amount LPLtgt. Therefore, the difference is referred to as “deviation DEVIpI(−)”.

The first device compensates for the deviation DEVIpI(-) by “increasing” the high-pressure EGR gas amount HPL. More specifically, the first device determines the “compensation profile” of the high-pressure EGR gas amount HPL at the timing t1. The compensation profile is determined so as to “increase the high-pressure EGR gas amount HPL by the amount corresponding to the deviation DEVIpI(−) during the period from the timing t1 to the timing t2” as illustrated in FIG. 4. Then, the first device increases the high-pressure EGR gas amount HPL according to the compensation profile.

The compensation profile can be determined by some method, for example by applying predetermined parameters (for example, the difference between the low-pressure EGR gas amount LPL and the target amount LPLtgt at the timing t1) to models (corresponding to the “control pattern”) that is designed based on the results of experiments conducted by using a typical engine having the same configuration of the engine 10. Furthermore, for example, the compensation profile can be determined applying the predetermined parameters to maps (corresponding to the “control pattern”) that are designed based on the results of experiments conducted by using the typical engine. In other words, the first device has predetermined control patterns and is configured to increases or decreases the high-pressure EGR gas amount HPL according to the control patterns.

The deviation DEVIpI (shortfall) is compensated when the high-pressure EGR gas amount HPL is increased according to the compensation profile. As a result thereof, the total amount HPL+LPL of the low-pressure EGR gas amount LPL and the high-pressure EGR gas amount HPL increases to the predetermined amount SUMtgt at the timing t1. The predetermined amount SUMtgt is the total amount when the deviation DEVIpI(−) is zero (that is, when it is assumed that the low-pressure EGR gas amount LPL instantly matches to the target amount LPLtgt at the timing t1), and therefore the amount is referred to as target total amount SUMtgt.

By the way, the more the EGR amount (the total amount HPL+LPL) entered into the combustion chamber, the less the NOx amount NOx, because of the decrease of combustion temperature. Therefore, the NOx amount NOx decreases to the predetermined amount NOxref at the timing t1. The predetermined amount NOxref is the NOx amount when the deviation DEVIpI(−) is zero (that is, when it is assumed that the low-pressure EGR gas amount LPL instantly matches to the target amount LPLtgt at the timing t1), and therefore the amount is referred to as reference amount NOxref.

As described above, “the difference of actual NOx amount NOx with reference to the reference amount NOxref” is referred to as NOx amount difference ΔNOx. The ΔNOx is zero after the timing t1 because the NOx amount NOx is matches to the reference amount NOxref after the timing t1.

Therefore, the deviation DEVIpI(−) is sufficiently compensated by the high-pressure EGR gas amount HPL when the increased amount of the high-pressure EGR gas amount HPL is “appropriate amount”. Accordingly, the NOx amount difference ΔNOx is kept at zero after the timing t1.

To the contrary thereof, the case where the increased or decreased amount is “not” an appropriate amount will be described below referring to FIG. 5. FIG. 5 is a time chart that illustrates the relationship between the EGR gas amount, the compensation profile, the NOx amount NOx, and the NOx amount difference ΔNOx, in the same manner as in FIG. 4.

The low-pressure EGR gas amount LPL matches to the target amount LPLtgt at the timing t2 when “the instruction to change the low-pressure EGR gas amount LPL toward a target amount LPLtgt” is given to the low-pressure EGR control valve 62c at the timing t1, in the same manner as above. Furthermore, the high-pressure EGR gas amount HPL is increased according to the compensation profile determined so as to compensate for the deviation DEVIpI(−).

In this case, however, it is assumed that the increased amount by the compensation profile is “larger” than the required amount (the broken line in FIG. 5) to compensate for the deviation DEVIpI(−). That is, it is assumed that the high-pressure EGR gas amount HPL is excessively increased. According to this assumption, the high-pressure EGR gas amount HPL from the timing t1 to the timing t2 is “larger” than the required amount (the broken line) to compensate for the deviation DEVIpI(−). Therefore, the total amount HPL+LPL is “larger” than the target total amount SUMtgt (the broken line) from the timing t1 to the timing t2. Then, the NOx amount NOx is “smaller” than the reference amount NOxref from the timing t1 to the timing t2. As a result thereof, the NOx amount difference ΔNOx of “negative value” occurs during this period.

The control pattern (such as the model) in the first device is corrected so that the NOx amount difference ΔNOx becomes smaller. More specifically, the control pattern is corrected so that the increased amount of the high-pressure EGR gas amount HPL is “decreased” while the NOx amount difference ΔNOx is “negative” (from the timing t1 to the timing t2), when the low-pressure EGR gas amount LPL is increased to the target amount LPLtgt.

By the above correction, the control pattern after the correction can compensate for the deviation DEVIpI(−) more appropriately compared with the control pattern before the correction.

By the way, it is understandable from the above description that the control pattern is corrected so that the increased amount of the high-pressure EGR gas amount HPL is “increased” while the NOx amount difference ΔNOx is “positive”, in the case that the NOx amount difference ΔNOx of “positive amount” occurs (that is, a NOx amount difference ΔNOx opposite to the example of FIG. 5 occurs) when the low-pressure EGR gas amount LPL is increased to the target amount LPLtgt.

2. Case where the low-pressure EGR gas amount decreases.

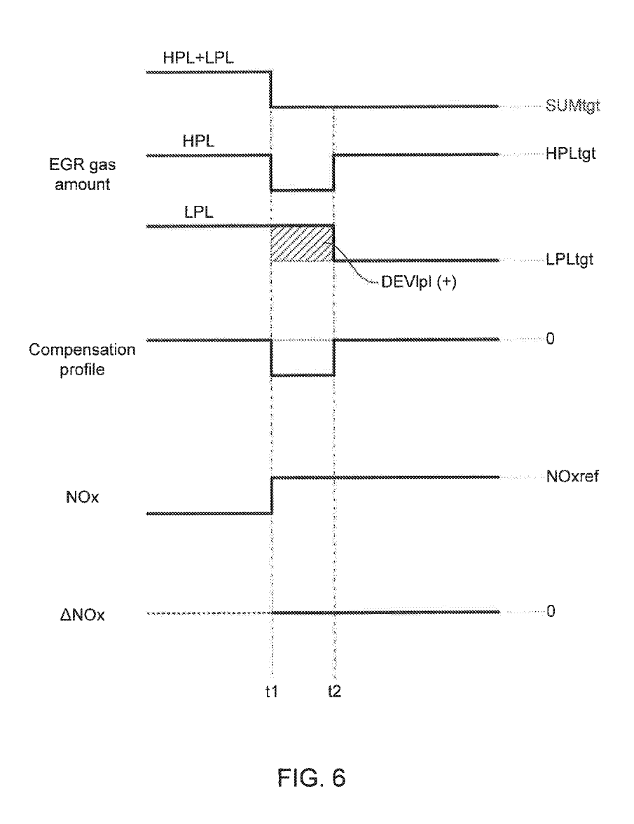

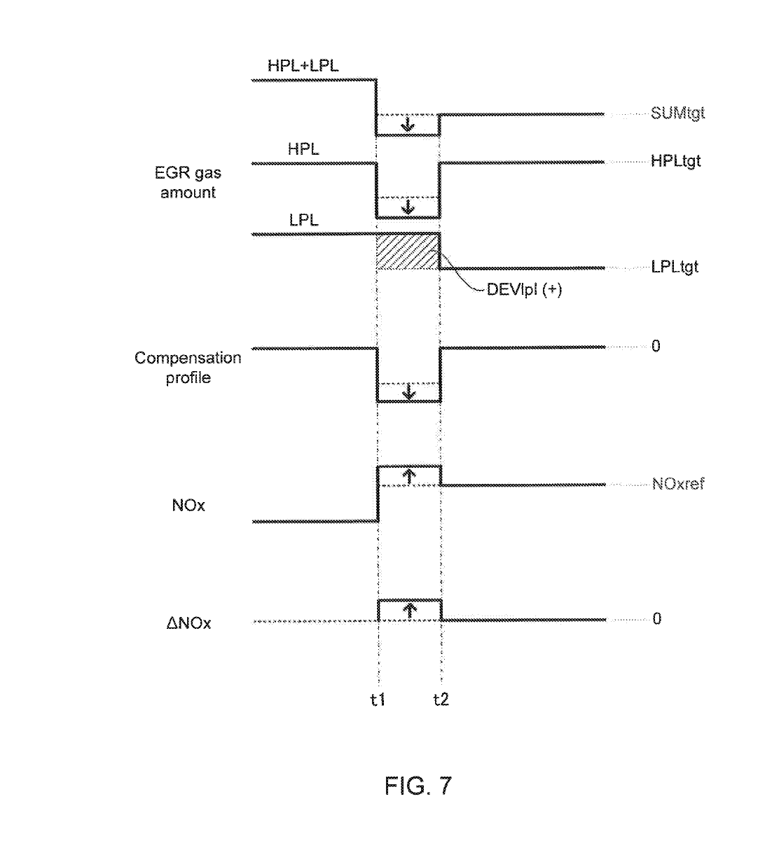

Next, it will be described that the control method of the amount of the EGR gas in the case that the amount of the low-pressure EGR gas “decreases” toward a target amount referring to the time charts illustrated in FIG. 6 and FIG. 7. FIG. 6 illustrates a time chart of an example where the increased or decreased amount of the amount of the high-pressure EGR gas to compensate for the difference is “an appropriate amount”, FIG. 7 illustrates a time chart of an example where the increased or decreased amount is “not” an appropriate amount. Each value in FIG. 6 and FIG. 7 is illustrated by simplifying each actual value for the sake of ease.

FIG. 6 is a time chart that illustrates the relationship between the EGR gas amount, the compensation profile, the NOx amount, and the NOx amount difference ΔNOx, in the same manner as FIG. 4 and FIG. 5.

In this time chart, the operating state of the engine 10 changes at the timing t1, and the instruction to “decrease the low-pressure EGR gas amount LPL toward a target amount LPLtgt” is given to the low-pressure EGR control valve 62c. It is assumed in FIG. 6 for the sake of ease that the high-pressure EGR gas amount HPL is not changed (that is, target amount HPLtgt is not increased or decreased) even when the operating state of the engine 10 is changed.

The low-pressure EGR gas amount LPL starts to decrease at the start time of the change (the timing t1) and matches the target amount LPLtgt at the end time of the change (the timing t2), after passing a predetermined time. As a result thereof, the difference is occurred between the target amount LPLtgt of the low-pressure EGR gas amount LPL and the low-pressure EGR gas amount LPL between the first timing t1 to the second timing t2. The difference is a positive value (in other words, excess) with reference to the target amount LPLtgt. Therefore, the difference is referred to as “deviation DEVIpI(+)”.

The first device compensates for the deviation DEVIpI(+) by “decreasing” the high-pressure EGR gas amount HPL. More specifically, the first device determines the “compensation profile” of the high-pressure EGR gas amount HPL at the timing t1. The compensation profile is determined so as to “decrease the high-pressure EGR gas amount HPL by the amount corresponding to the deviation DEVIpI(+) during the period from the timing t1 to the timing t2” as illustrated in FIG. 6. Then, the first device increases the high-pressure EGR gas amount HPL according to the compensation profile. In addition, the compensation profile is determined based on the predetermined control patterns (for example, the models) in the same manner as above.

The deviation DEVIpI (excess) is compensated when the high-pressure EGR gas amount HPL is decreased according to the compensation profile. As a result thereof, the total amount HPL+LPL of the low-pressure EGR gas amount LPL and the high-pressure EGR gas amount HPL increases to the predetermined amount SUMtgt (hereinafter referred to as “target amount LPLtgt” in the same manner as above) at the timing t1. Furthermore, the NOx amount NOx decreases to the predetermined amount NOxref (hereinafter referred to as “reference amount NOxref” in the same manner as above) at the timing t1. As a result thereof, the NOx amount difference ΔNOx is zero after the timing t1 in this example.

Therefore, the deviation DEVIpI(+) is sufficiently compensated by the high-pressure EGR gas amount HPL when the decreased amount of the high-pressure EGR gas amount HPL is “appropriate amount”. Accordingly, the NOx amount difference ΔNOx is kept at zero after the timing t1.

To the contrary thereof, the case where the increased or decreased amount is “not” an appropriate amount will be described below referring to FIG. 7. FIG. 7 is a time chart that illustrates the relationship between the EGR gas amount, the compensation profile, the NOx amount NOx, and the NOx amount difference ΔNOx, in the same manner as in FIG. 6.

The low-pressure EGR gas amount LPL matches to the target amount LPLtgt at the timing t2 when “the instruction to increase the low-pressure EGR gas amount LPL toward a target amount LPLtgt” is given to the low-pressure EGR control valve 62c at the timing t1, in the same manner as above. Furthermore, the high-pressure EGR gas amount HPL is decreased according to the compensation profile determined so as to compensate for the deviation DEVIpI(+).

In this case, however, it is assumed that the decreased amount by the compensation profile is “larger” than the required amount (the broken line in FIG. 7) to compensate for the deviation DEVIpI(+). That is, it is assumed that the high-pressure EGR gas amount HPL is excessively decreased. According to this assumption, the high-pressure EGR gas amount HPL from the timing t1 to the timing t2 is “smaller” than the required amount (the broken line) to compensate for the deviation DEVIpI(+). Therefore, the total amount HPL+LPL is “smaller” than the target total amount SUMtgt (the broken line) from the timing t1 to the timing t2. Then, the NOx amount NOx is “larger” than the reference amount NOxref from the timing t1 to the timing t2. As a result thereof, the NOx amount difference ΔNOx of “positive value” occurs during this period.

The control pattern (such as the model) in the first device is corrected so that the NOx amount difference ΔNOx becomes smaller. More specifically, the control pattern is corrected so that the increased amount of the high-pressure EGR gas amount HPL is “increased” while the NOx amount difference ΔNOx is “positive” (from the timing t1 to the timing t2), when the low-pressure EGR gas amount LPL is increased to the target amount LPLtgt.

By the above correction, the control pattern after the correction can compensate for the deviation DEVIpI(+) more appropriately compared with the control pattern before the correction.

By the way, it is understandable that the control pattern is corrected so that the increased amount of the high-pressure EGR gas amount HPL is “increased” while the NOx amount difference ΔNOx is “negative”, in the case that the NOx amount difference ΔNOx of “negative amount” occurs (that is, a NOx amount difference ΔNOx opposite to the example of FIG. 6 occurs) when the low-pressure EGR gas amount LPL is decreased to the target amount LPLtgt.

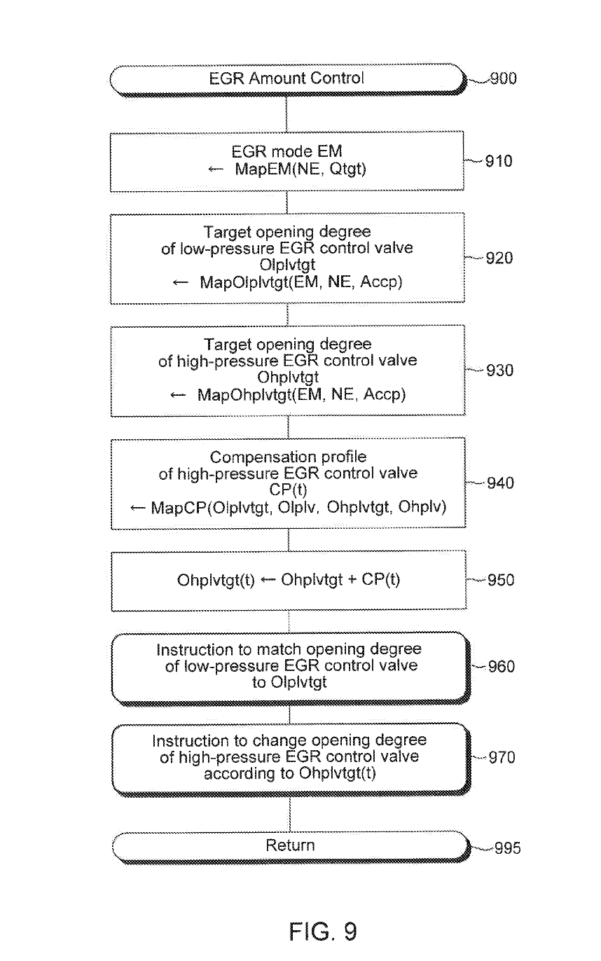

As described above, it is assumed in the description referring to FIG. 4 to FIG. 7 that only the target amount LPLtgt of the low-pressure EGR gas amount LPL changes but the high-pressure EGR gas amount HPL is not changed, when the operating state of the engine 10 is changed. On the other hand, both of the target amount LPLtgt of the low-pressure EGR gas amount LPL and the target amount HPLtgt of the high-pressure EGR gas amount HPL may change actually when the operating state of the engine 10 is changed. it is understandable, however, that the deviation DEVIpI of the low-pressure EGR gas amount LPL can be appropriately compensated by controlling the high-pressure EGR gas amount HPL with consideration for the both of the change of the target amount HPLtgt and the compensation profile, even when the target amount HPLtgt of the high-pressure EGR gas amount HPL changes (for example, see the routine of FIG. 9). These are the control methods of the EGR gas.

### <Actual Operation>

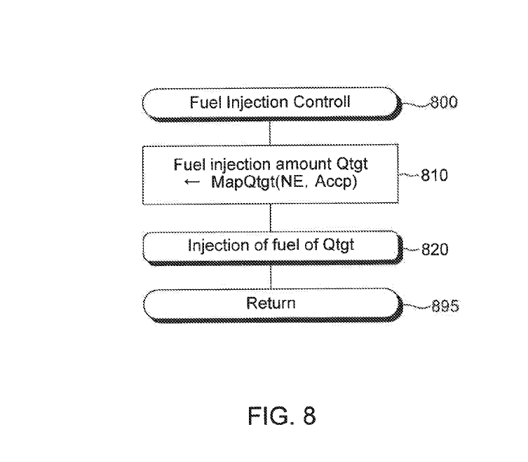

Hereinafter, an actual operation of the first device will be described. Regarding the first device, the CPU 91 is configured to execute the respective routines indicated by the flowcharts in FIG. 8 to FIG. 10 at every predetermined timing. Hereinafter, the respective routines performed by the CPU 91 will be described in detail.

The CPU 91 is configured to repeatedly execute the “fuel-injection-control routine”, which is indicated by the flow chart in FIG. 8, every time the crank angle of arbitrary cylinder becomes equal to a predetermined crank angle before the intake stroke (for example, the crank angle of 90 degrees before the exhaust top dead center) 8f. By this routine, the CPU 91 determines the target value Qtgt of the fuel injection amount and sends an instruction for injecting fuel into the respective cylinder in the amount of the target value Qtgt. Hereinafter, the cylinder where the crank angle is equal to the predetermined crank angle 8f before the intake stroke is referred to as “fuel injection cylinder”.

More specifically, the CPU 91 starts a process at step 800 of FIG. 8 and then proceeds to step 810 at a predetermined time. The CPU 91 determines the target value Qtgt of the fuel injection amount at step 810 by applying an accelerator opening degree Accp and an engine rotation speed NE at this moment to a table MapQtgt(NE, Accp) for defining the target value of the fuel injection amount. The table defines “the relationship between the accelerator opening degree Accp, the engine rotation speed NE, and the target value Qtgt of the fuel injection amount” in advance.

Regarding this table MapQtgt(NE, Accp) for defining the target value of the fuel injection amount, the target value Qtgt of the fuel injection amount is determined to be an appropriate value that is set depending on a required torque, fuel consumption rate, amount of emission, and etc.

Next, the CPU 91 proceeds to step 820. At step 820, the CPU 91 sends an instruction to the fuel injecting device 22 so as to inject the fuel in the amount of the target value Qtgt. By this instruction, the fuel in the amount of the target value Qtgt is injected into the fuel injection cylinder. After that, the CPU 91 proceeds to step 895 so as to end this routine once.

Furthermore, the CPU 91 is configured to repeatedly execute the “EGR-amount-control routine”, which is indicated by the flowchart in FIG. 9, every time a predetermined time period elapses. By this routine, the CPU 91 controls the low-pressure EGR gas amount LPL and the high-pressure EGR gas amount HPL with consideration of the operating state of the engine 10 and the compensation of the deviations.

More specifically, the CPU 91 starts a process at step 900 of FIG. 9 and then proceeds to step 910 at a predetermined time. At step 910, the CPU 91 determines the EGR mode EM (see FIG. 3) By applying an engine rotational speed NE and the target amount Qtgt of fuel injection amount at this moment to the above EGR mode table MapEM(NE, Qtgt).

Next, the CPU 91 proceeds to step 920. At step 920, the CPU 91 determines the target opening degree Olplvtgt of the low-pressure EGR control valve 62c by applying an EGR mode EM, an engine rotation speed NE, and an accelerator opening degree Accp at this moment to a table MapOlplvtgt(EM, NE, Accp) for defining the target opening degree of the low-pressure EGR control valve. The table defines “the relationship between the EGR mode EM, the engine rotation speed NE, the accelerator opening degree Accp, and the target opening degree Olplvtgt of the low-pressure EGR control valve 62c” in advance.

Regarding this table MapOlplvtgt(EM, NE, Accp) for defining the target opening degree of the low-pressure EGR control valve, the target opening degree Olplvtgt is determined to be an appropriate value that is set depending on the amount of emission, a required output of the engine 10, and etc.

Next, the CPU 91 proceeds to step 930. At step 930, the CPU 91 determines the target opening degree Ohplvtgt of the high-pressure EGR control valve 61c by applying an EGR mode EM, an engine rotation speed NE, and an accelerator opening degree Accp at this moment to a table MapOhplvtgt(EM, NE, Accp) for defining the target opening degree of the high-pressure EGR control valve. The table defines “the relationship between the EGR mode EM, the engine rotation speed NE, the accelerator opening degree Accp, and the target opening degree Ohplvtgt of the high-pressure EGR control valve 61c” in advance.

Regarding this table MapOhplvtgt(EM, NE, Accp) for defining the target opening degree of the high-pressure EGR control valve, the target opening degree Ohplvtgt is determined to be an appropriate value that is set depending on amount of emission, a required output of the engine 10, and etc.

Next, the CPU 91 proceeds to step 940. At step 940, the CPU 91 determines the compensation profile CP(t) by applying the target opening degree Olplvtgt of the low-pressure EGR control valve 62c, an opening degree OlpIv of the low-pressure EGR control valve 62c at this moment, the target opening degree Ohplvtgt of the high-pressure EGR control valve 61c, and an opening degree OhpIv of the high-pressure EGR control valve 61c at this moment to a table MapCP(Olplvtgt, OlpIv, Ohplvtgt, OhpIv) for defining the compensation profile. The table defines “the relationship between the target opening degree Olplvtgt of the low-pressure EGR control valve 62c, the opening degree OlpIv of the low-pressure EGR control valve 62c at this moment, the target opening degree Ohplvtgt of the high-pressure EGR control valve 61c, and the opening degree OhpIv of the high-pressure EGR control valve 61c at this moment” in advance. In addition, the table MapCP(Olplvtgt, OlpIv, Ohplvtgt, OhpIv) corresponds to the “control pattern” described above.

Regarding this table MapCP(Olplvtgt, OlpIv, Ohplvtgt, OhpIv) for defining the compensation profile, the compensation profile CP(t) is determined to be an appropriate value by which the deviations of the low-pressure EGR gas amount LPL can be compensated appropriately. The compensation profile CP(t) of the first device is determined as a “profile representing increasing amount or decreasing amount of the high-pressure EGR gas amount HPL with reference to time”.

Next, the CPU 91 proceeds to step 950. At step 950, the CPU 91 determines a target transition Ohplvtgt(t), which represents actual transition of the opening degree of the high-pressure EGR control valve 61c, by adding the compensation profile CP(t) to the target opening degree Ohplvtgt.

Next, the CPU 91 proceeds to step 960. At step 960, the CPU 91 sends an instruction to the low-pressure EGR control valve 62c so as to match the opening degree of the low-pressure EGR control valve 62c to the target opening degree Olplvtgt. In addition, the timing at which the operation of step 960 is carried out corresponds to “the timing t1” in FIG. 4 to FIG. 7.

Next, the CPU 91 proceeds to step 970. At step 970, the CPU 91 sends an instruction to the high-pressure EGR control valve 61c so as to match the opening degree of the high-pressure EGR control valve 61c to the target opening degree Ohplvtgt. In addition, the timing at which the operation of step 970 is carried out corresponds to “the timing t1” in FIG. 4 to FIG. 7. After that, the CPU 91 proceeds to step 995 so as to end this routine once.

By the above operation, the deviations of the low-pressure EGR gas amount LPL during the period from the timing t1 to the timing t2 is compensated by the high-pressure EGR gas amount HPL. Hereinafter, the period from the timing t1 to the timing t2 is referred to as “compensation period of EGR gas amount” for convenience.

By the way, the CPU 91 continues to obtain the NOx amount NOx included in exhaust gas with reference to time. Hereinafter, the relationship between the NOx amount NOx with reference to time is referred to as “NOx amount transition NOx(t)”. The CPU 91 corrects “the table MapCP(Olplvtgt, Olplv, Ohplvtgt, OhpIv) for defining the compensation profile” as necessary, based on NOx amount difference transition ΔNOx(t) that is the difference between the NOx amount transition NOx(t) and a predetermined referential NOx amount transition NOxref(t). Hereinafter, the table MapCP(Olplvtgt, Olplv, Ohplvtgt, OhpIv) is simply referred to as “compensation profile table MapCP”.

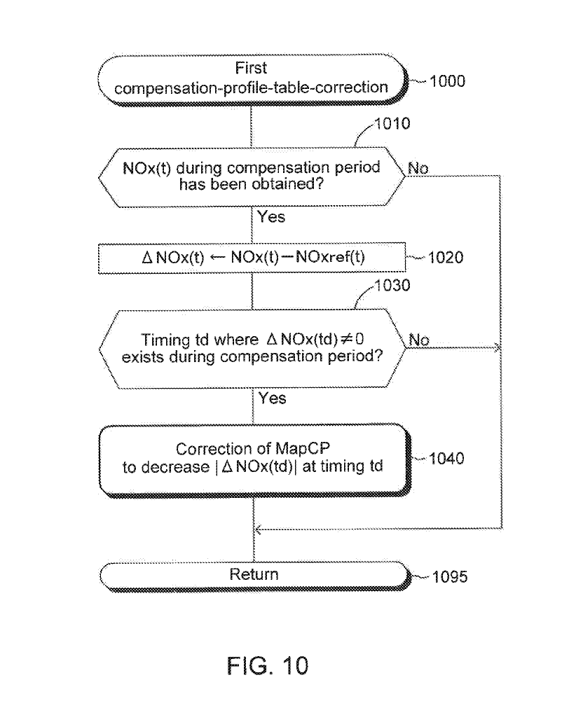

More specifically, the CPU 91 is configured to repeatedly execute the “first compensation-profile-table-correction routine”, which is indicated by the flow chart in FIG. 10, every time a predetermined time period elapses. By this routine, the CPU 91 corrects the compensation profile table MapCP as necessary.

That is, the CPU 91 starts a process at step 1000 of FIG. 10 and then proceeds toward step 1010 at a predetermined timing. At step 910, the CPU 91 determines whether or not the NOx amount transition NOx(t) during the compensation period of EGR gas amount has already obtained at this moment.

The CPU 91 makes the “No” determination at step 1010 when the NOx amount transition NOx(t) has not yet obtained at this moment (for example, during the compensation period of EGR gas amount). Then, the CPU 91 proceeds to step 1095 so as to end this routine once. Therefore, the compensation profile table MapCP is not corrected when the NOx amount transition NOx(t) has not yet obtained at this moment.

To the contrary, the CPU 91 makes the “Yes” determination at step 1010 when the NOx amount transition NOx(t) has already obtained at this moment to proceed to step 1020.

At step 1020, the CPU 91 obtains the NOx amount difference transition ΔNOx(t) by subtracting the referential NOx amount transition NOxref(t) from the NOx amount transition NOx (t). Therefore, the NOx amount difference transition ΔNOx(t) becomes “positive value” at the timing where the NOx amount transition NOx(t) is larger than the referential NOx amount transition NOxref(t), the NOx amount difference transition ΔNOx(t) becomes “negative value” at the timing where the NOx amount transition NOx(t) is smaller than the referential NOx amount transition NOxref(t).

The referential NOx amount transition NOxref(t) represents the relationship between the NOx amount NOx and time on the assumption that the deviation of the low-pressure EGR gas amount LPL is zero. The referential NOx amount transition NOxref(t) can be determined based on maps obtained in advance and defining the relationship between the EGR gas amount and the NOx amount NOx, etc.

Next, the CPU 91 proceeds to step 1030. At step 1030, the CPU 91 determines whether or not there is any timing td where the NOx amount difference transition ΔNOx(t) is not zero (the timing td at which ΔNOx(dt)≠0 is satisfied) during the compensation period of EGR gas amount.

It is thought that the high-pressure EGR gas amount HPL is appropriately controlled, when the timing td “does not exist”. Therefore, the CPU 91 makes the “No” determination at step 1030 when the timing td is “not exist” to proceed to step 1095 so as to end this routine once. Accordingly, the compensation profile table MapCP is not corrected in this case.

To the contrary, it is thought that the high-pressure EGR gas amount HPL is not appropriately controlled, when the timing td “exists”. Therefore, the CPU 91 makes the “Yes” determination at step 1030 when the timing td “exists” to proceed to step 1040.

At step 1040, the CPU 91 corrects the compensation profile table MapCP so that the absolute value of the NOx amount difference ΔNOx at the timing td (IΔNOx (td)|) becomes smaller. Then, the CPU 91 proceeds to step 1095 so as to end this routine once.

As described above, the CPU 91 compensates for the deviation DEVIpI of the low-pressure EGR gas amount LPL by increasing or decreasing the high-pressure EGR gas amount HPL based on the compensation profile CP(t). Furthermore, the CPU 91 corrects the compensation profile table MapCP, which is used to determine the compensation profile CP(t), based on the NOx amount difference transition ΔNOx(t) during the compensation period of EGR gas amount. By the above operation, the corrected compensation profile table MapCP can determine the compensation profile CP(t) that is more appropriate in the viewpoint of the compensation for the deviation DEVIpI compared with the table before the correction. As a result thereof, the deviation DEVIpI of the low-pressure EGR gas amount LPL is compensated more surely.

### <General Overview of First Embodiment>

As described referring to FIG. 1 to FIG. 10, the control device according to the first embodiment of the invention (the first device) is applied to the engine 10 having,

“first means (the low-pressure EGR system) 62 for recirculating exhaust gas” discharged from a combustion chamber of the engine 10 to an exhaust passage 42 toward an intake passage 32 through first passage 62a, and “second means (the high-pressure EGR system) 61 for recirculating exhaust gas” discharged from the combustion chamber to the exhaust passage 42 toward the intake passage 32 through second passage 61 a different from the first passage 62a.

The first device comprising,

control means for controlling recirculated gas amount, the control means controlling first recirculated gas amount (low-pressure EGR gas amount) LPL and second recirculated gas amount (high-pressure EGR gas amount) HPL, the first recirculated gas amount LPL being an amount of exhaust gas recirculated by the first means 62 and entered into the combustion chamber, the second recirculated gas amount HPL being an amount of exhaust gas recirculated by the second means 61 and entered into the combustion chamber.

More specifically,

the first means 62 has a first control valve 62c to change an amount of exhaust gas passing through the first passage 62a, the second means 61 has a second control valve 61 c to change an amount of exhaust gas passing through the second passage 61a. However, the first means 62 and the second means 61 does not necessarily have control valves but have any configuration that can control the first recirculated gas amount LPL and the second recirculated gas amount HPL.

The control means has a predetermined control pattern (for example, the compensation profile table MapCP in FIG. 9) to increase or decrease the second recirculated gas amount HPL to compensate for a difference (for example, DEVIpI(−) in FIG. 4) of the first recirculated gas amount LPL with reference to a target amount (for example, target amount LPLtgt in FIG. 4), and increasing or decreasing the second recirculated gas amount HPL according to the control pattern MapCP during a period from a start time of change (for example, the timing t1 in FIG. 4) to an end time of change(for example, the timing t2 in FIG. 4), the start time being a moment of the first recirculated gas amount LPL being started to change toward the target amount LPLtgt, the end time being a moment of the first recirculated gas amount LPL being reached to the target amount LPLtgt.

In the first device, the control pattern MapCP is corrected as necessary based on the index (NOx) related to the recirculated gas amount that a constituent having an amount decreasing with increasing total amount HPL+LPL of the exhaust gas recirculated by the first means 62 and the second means 61 and entered into the combustion chamber.

More specifically,

(1) In the case that the target amount LPLtgt of the first recirculated gas amount LPL is changed and the first recirculated gas amount LPL is “increased” toward the target amount LPLtgt (for example, see FIG. 5):

The control pattern is corrected to “increase an increased amount of the second recirculated gas amount HPL” at a moment of occurrence of the difference ΔNOx of the index of a positive value or a moment just before the occurrence thereof, upon the difference ΔNOx of the index is the “positive value”. On the other hand, the control pattern is corrected to “decrease an increased amount of the second recirculated gas amount HPL” at a moment of occurrence of the difference ΔNOx of the index of a negative value or a moment just before the occurrence thereof, upon the difference ΔNOx of the index is the “negative value”.

(2) In the case that the target amount LPLtgt of the first recirculated gas amount LPL is changed and the first recirculated gas amount LPL is “decreased” toward the target amount LPLtgt (for example, see FIG. 7):

The control pattern is corrected to “decrease a decreased amount of the second recirculated gas amount HPL” at a moment of occurrence of the difference ΔNOx of the index of a positive value or a moment just before the occurrence thereof, upon the difference ΔNOx of the index is the “positive value”. The control pattern is corrected to “increase a decreased amount of the second recirculated gas amount HPL” at a moment of occurrence of the difference ΔNOx of the index of a negative value or a moment just before the occurrence thereof, upon the difference ΔNOx of the index is the “negative value”.

By the way, in the first device, “nitrogen oxide (NOx)” is employed as the index. However, the index is not necessarily NOx. For example, oxygen (in other words, air-fuel ratio) may be employed as the index.

That is, at least one of nitrogen oxide and oxygen included in the exhaust gas discharged from the combustion chamber may be employed as the index.

Furthermore, the index does not necessarily the constituent having an amount “decreasing” with increasing total amount HPL+LPL of the exhaust gas. For example, a constituent having an amount “increasing” with increasing total amount H PL+LPL of the exhaust gas (for example, THC (total hydrocarbon)) may be employed as the index.

The control pattern may be corrected according to a different concept (for example, the opposite concept) from the concept in the above (1) and the above (2).

More specifically,

(1′) In the case that the target amount of the first recirculated gas amount is changed and the first recirculated gas amount is “increased” toward the target amount:

The control pattern may be corrected to “decrease” an increased amount of the second recirculated gas amount at a moment of occurrence of the difference of the index of a positive value or a moment just before the occurrence thereof, upon the difference of the index is the positive value. On the other hand, the control pattern may be corrected to “increase” an increased amount of the second recirculated gas amount at a moment of occurrence of the difference of the index of a negative value or a moment just before the occurrence thereof, upon the difference of the index is the negative value.

(2′) In the case that the target amount of the first recirculated gas amount is changed and the first recirculated gas amount is “decreased” toward the target amount:

The control pattern may be corrected to “increase” a decreased amount of the second recirculated gas amount at a moment of occurrence of the difference of the index of a positive value or a moment just before the occurrence thereof, upon the difference of the index is the positive value. On the other hand, the control pattern may be corrected to “decrease” a decreased amount of the second recirculated gas amount at a moment of occurrence of the difference of the index of a negative value or a moment just before the occurrence thereof, upon the difference of the index is the negative value.

That is, the control device of the invention may be configured so that,

the control pattern is corrected based on whether the difference ΔNOx of the index during the period from the start time to the end time being zero, positive value, and negative value.

As described above, in the control device of the invention,

the control pattern is corrected to decrease a difference ΔNOx of index related to the recirculated gas amount, upon an actual amount of the index NOx not matching a referential amount thereof while the second recirculated gas amount HPL being increased or decreased according to the control pattern during the period from the start time t1 to the end time t2, the index is a “constituent included in the exhaust gas discharged from a combustion chamber to the exhaust passage 42, and an amount of the constituent varying depending on total amount HPL+LPL of the exhaust gas recirculated by the first means 62 and the second means 61 and entered into the combustion chamber”, the difference ΔNOx of the index is a difference ΔNOx of the actual amount with reference to the referential amount.

### Second Embodiment

### <Outline of Device>

The second device is applied to the internal combustion engine that has the same configuration as the engine 10 to which the first device is applied (see FIG. 1. Hereinafter referred to as “engine 10” for convenience). Therefore, the description for the outline of the engine to which the second device is applied is omitted.

### <Outline of Operation of Device>

Hereinafter, the outline of the operation of the second device employed in the engine 10 will be described.

The second device is different from the first device in that the control pattern is corrected so as to control “the timing to increase or decrease the high-pressure EGR gas amount HPL”.

More specifically, the second device determines the compensation profile based on predetermined control pattern, and compensates for the deviation of the low-pressure EGR gas by increasing or decreasing the amount of the high-pressure EGR gas according to the control pattern. That is, the second device corrects the control pattern (the compensation profile table) so that the timing to start the increase or decrease of the high-pressure EGR gas amount becomes earlier (or delayed) when the NOx amount difference transition ΔNOx(t) during the compensation period of EGR gas amount satisfies a predetermined condition. These are the outline of the operation of the second device.

### <Determination Method for EGR Mode >

The second device determines the EGR mode by the same method as the first device. Therefore, the description for the determination method for the EGR mode is omitted.

### <Control Method of EGR Gas Amount>

Next, the control methods of the amount of EGR gas (the amounts of the high-pressure EGR gas and the low-pressure EGR gas) of the second device will be described below for a case where the amount of the low-pressure EGR gas “increases” and a case where the amount of the low-pressure EGR gas “decreases.”

1. Case where the low-pressure EGR gas amount increases.

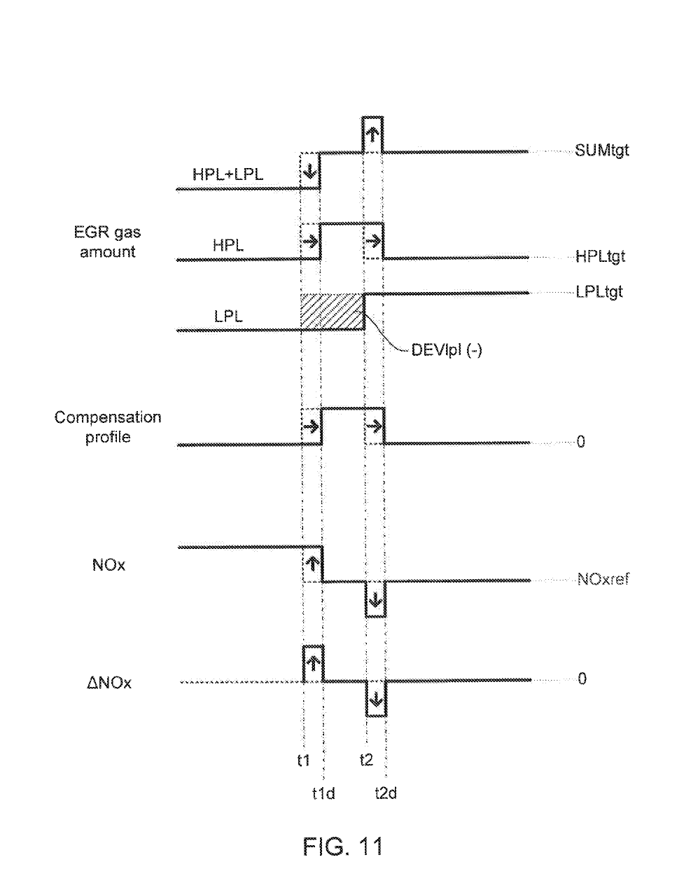

It will be described that the control method of the amount of the EGR gas in the case that the amount of the low-pressure EGR gas “increases” toward a predetermined target amount referring to the time charts illustrated in FIG. 4 and FIG. 11. FIG. 4 illustrates a time chart of an example where the increased or decreased amount of the amount of the high-pressure EGR gas is “an appropriate amount” as noted above, FIG. 11 illustrates a time chart of an example where the increased or decreased amount is “not” an appropriate amount. Each value in FIG. 4 and FIG. 11 is illustrated by simplifying each actual value for the sake of ease.

The deviation DEVIpI(−) is sufficiently compensated by the high-pressure EGR gas amount HPL when the increased amount of the high-pressure EGR gas amount HPL is “appropriate amount”, as described for the first device referring to FIG. 4. Accordingly, the NOx amount difference ΔNOx is kept at zero after the timing t1.

To the contrary thereof, the case where the increased or decreased amount is “not” an appropriate amount will be described below referring to FIG. 11. FIG. 11 is a time chart that illustrates the relationship between the EGR gas amount, the compensation profile, the NOx amount NOx, and the NOx amount difference ΔNOx, in the same manner as in FIG. 4. In addition, the compensation profile can be determined based on the control pattern (for example, models designed by using a typical engine) as same as the first device.

The low-pressure EGR gas amount LPL matches to the target amount LPLtgt at the timing t2 when “the instruction to change the low-pressure EGR gas amount LPL toward a target amount LPLtgt” is given to the low-pressure EGR control valve 62c at the timing t1, in the same manner as FIG. 4. Furthermore, the high-pressure EGR gas amount HPL is increased according to the compensation profile determined so as to compensate for the deviation DEVIpI(−).

In this case, however, it is assumed in this example that the compensation profile is determined not to start increasing the high-pressure EGR gas amount HPL at the timing t1 (start time of change) but to start increasing it at “timing t1d that is after the timing t1”. Furthermore, the timing at which the high-pressure EGR gas amount HPL finishes to increase becomes delayed since the timing at which the high-pressure EGR gas amount HPL starts to increase is delayed, and therefore, it is assumed that the compensation profile is determined not to finish increasing the high-pressure EGR gas amount HPL at the timing t2 (end time of change) but to finish increasing it at “timing t2d that is after the timing t2”. That is, it is assumed that the start time and the finish timing of the increase of the high-pressure EGR gas amount HPL are delayed.

According to the above assumptions, the high-pressure EGR gas amount HPL during the period from the timing t1 to the timing t1d is “smaller” than the required amount (the broken line) to compensate for the deviation DEVIpI(−). Therefore, the total amount HPL+LPL is “smaller” than the target total amount SUMtgt (the broken line) during this period. Then, the NOx amount NOx is “larger” than the reference amount NOxref during this period. As a result thereof, the NOx amount difference ΔNOx of “positive value” occurs during this period.

On the other hand, the high-pressure EGR gas amount HPL during the period from the timing t2 to the timing t2d is “larger” than the required amount (the broken line) to compensate for the deviation DEVIpI(−). Therefore, the total amount HPL+LPL is “larger” than the target total amount SUMtgt (the broken line) during this period. Then, the NOx amount NOx is “smaller” than the reference amount NOxref during this period. As a result thereof, the NOx amount difference ΔNOx of “negative value” occurs during this period.

The control pattern (such as the model) in the second device is corrected so that both of these NOx amount differences ΔNOx become smaller. More specifically, the control pattern is corrected so that “the start of increasing the high-pressure EGR gas amount HPL becomes earlier”, when the NOx amount difference ΔNOx is “positive” at a timing around the start time of the change (the timing t1) and the NOx amount difference ΔNOx is “negative” at a timing around the end time of the change (the timing t2), in the case that the low-pressure EGR gas amount LPL is increased to the target amount LPLtgt.

By the above correction, the control pattern after the correction can compensate for the deviation DEVIpI(−) more appropriately compared with the control pattern before the correction.

By the way, it is understandable from the above description that the control pattern is corrected so that “the start of increasing the high-pressure EGR gas amount HPL becomes delayed”, when the NOx amount difference ΔNOx is “negative” at a timing around the start time of the change and the NOx amount difference ΔNOx is “positive” at a timing around the end time of the change (that is, a NOx amount difference ΔNOx opposite to the example of FIG. 11 occurs), in the case that the low-pressure EGR gas amount LPL is increased to the target amount LPLtgt.

2. Case where the low-pressure EGR gas amount decreases.

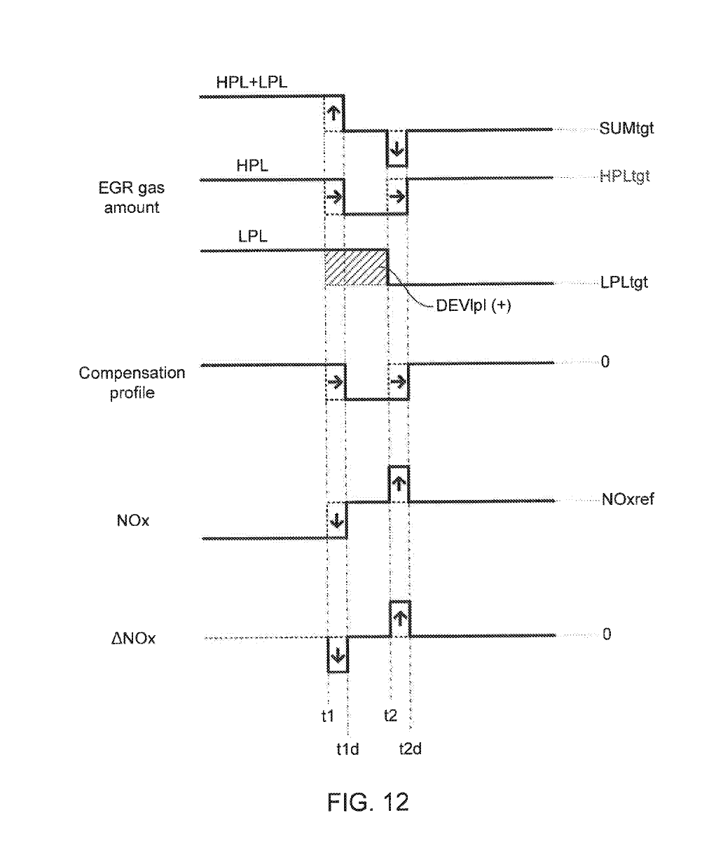

Next, it will be described that the control method of the amount of the EGR gas in the case that the amount of the low-pressure EGR gas “decreases” toward a target amount referring to the time charts illustrated in FIG. 6 and FIG. 12. FIG. 6 illustrates a time chart of an example where the increased or decreased amount of the amount of the high-pressure EGR gas is “an appropriate amount” as described above, FIG. 12 illustrates a time chart of an example where the increased or decreased amount is “not” an appropriate amount. Each value in FIG. 6 and FIG. 12 is illustrated by simplifying each actual value for the sake of ease.

The deviation DEVIpI(+) is sufficiently compensated by the high-pressure EGR gas amount HPL when the decreased amount of the high-pressure EGR gas amount HPL is “appropriate amount”, as described for the first device referring to FIG. 6. Accordingly, the NOx amount difference ΔNOx is kept at zero after the timing t1.

To the contrary thereof, the case where the increased or decreased amount is “not” an appropriate amount will be described below referring to FIG. 12. FIG. 12 is a time chart that illustrates the relationship between the EGR gas amount, the compensation profile, the NOx amount NOx, and the NOx amount difference ΔNOx, in the same manner as in FIG. 6. In addition, the compensation profile can be determined based on the control pattern (for example, models designed by using a typical engine) as same as the first device.

The low-pressure EGR gas amount LPL matches to the target amount LPLtgt at the timing t2 when “the instruction to change the low-pressure EGR gas amount LPL toward a target amount LPLtgt” is given to the low-pressure EGR control valve 62c at the timing t1, in the same manner as FIG. 4. Furthermore, the high-pressure EGR gas amount HPL is decreased according to the compensation profile determined so as to compensate for the deviation DEVIpI(+).

In this case, however, it is assumed in this example that the compensation profile is determined not to start decreasing the high-pressure EGR gas amount HPL at the timing t1 (start time of change) but to start decreasing it at “timing t1 d that is after the timing t1”. Furthermore, the timing at which the high-pressure EGR gas amount HPL finishes to decrease becomes delayed since the timing at which the high-pressure EGR gas amount HPL starts to decrease is delayed, and therefore, it is assumed that the compensation profile is determined not to finish decreasing the high-pressure EGR gas amount HPL at the timing t2 (end time of change) but to finish decreasing it at “timing t2d that is after the timing t2”. That is, it is assumed that the start time and the finish timing of the decrease of the high-pressure EGR gas amount HPL are delayed.

According to the above assumptions, the high-pressure EGR gas amount HPL during the period from the timing t1 to the timing t1d is “larger” than the required amount (the broken line) to compensate for the deviation DEVIpI(+). Therefore, the total amount HPL+LPL is “larger” than the target total amount SUMtgt (the broken line) during this period. Then, the NOx amount NOx is “smaller” than the reference amount NOxref during this period. As a result thereof, the NOx amount difference ΔNOx of “negative value” occurs during this period.

On the other hand, the high-pressure EGR gas amount HPL during the period from the timing t2 to the timing t2d is “smaller” than the required amount (the broken line) to compensate for the deviation DEVIpI(+). Therefore, the total amount HPL+LPL is “smaller” than the target total amount SUMtgt (the broken line) during this period. Then, the NOx amount NOx is “larger” than the reference amount NOxref during this period. As a result thereof, the NOx amount difference ΔNOx of “positive value” occurs during this period.

The control pattern (such as the model) in the second device is corrected so that both of these NOx amount differences ΔNOx become smaller. More specifically, the control pattern is corrected so that “the start of decreasing the high-pressure EGR gas amount HPL becomes earlier”, when the NOx amount difference ΔNOx is “negative” at a timing around the start time of the change (the timing t1) and the NOx amount difference ΔNOx is “positive” at a timing around the end time of the change (the timing t2), in the case that the low-pressure EGR gas amount LPL is decreased to the target amount LPLtgt.

By the above correction, the control pattern after the correction can compensate for the deviation DEVIpI(+) more appropriately compared with the control pattern before the correction.

By the way, it is understandable from the above description that the control pattern is corrected so that “the start of decreasing the high-pressure EGR gas amount HPL becomes delayed”, when the NOx amount difference ΔNOx is “positive” at a timing around the start time of change and the NOx amount difference ΔNOx is “negative” at a timing around the end time of change (that is, a NOx amount difference ΔNOx opposite to the example of FIG. 12 occurs), in the case that the low-pressure EGR gas amount LPL is decreased to the target amount LPLtgt.

### <Actual Operation>

Hereinafter, an actual operation of the second device will be described.

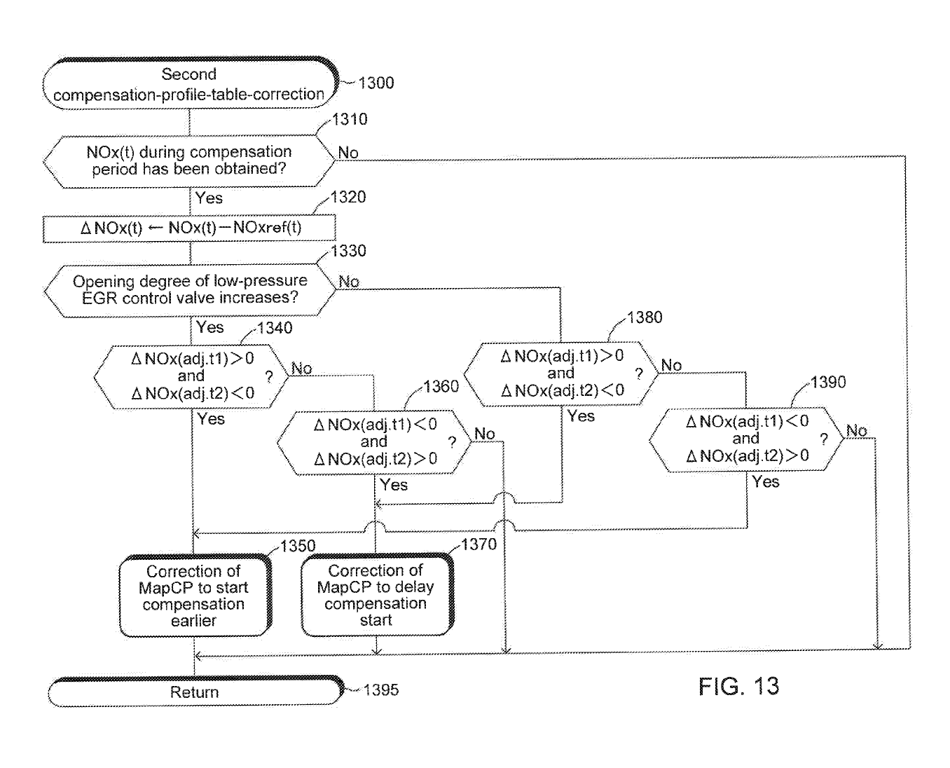

The second device is different from the first device only in the CPU 91 executes the routine indicated by the flowcharts in FIG. 13 instead of the routine indicated by the flow charts in FIG. 10. Therefore, the following descriptions will be mainly concerned these differences.

The CPU 91 is configured to repeatedly execute the routines of FIG. 8 and FIG. 9 at a predetermined timing. That is, the second device determines the target amount Qtgt of fuel injection amount based on the engine rotation speed NE and the accelerator opening degree Accp (the routine of FIG. 8). Furthermore, the second device determines the EGR mode EM based on the target amount Qtgt and the engine rotation speed NE (step 910 of FIG. 9), and determines the target opening degree Olplvtgt of the low-pressure EGR control valve 62c and the target opening degree Ohplvtgt of the high-pressure EGR control valve 61c (step 920 and step 930 of FIG. 9). Next, the second device determines the target transition Ohplvtgt(t) of the high-pressure EGR control valve 61c by combining the target opening degree Ohplvtgt of the high-pressure EGR control valve 61c and the compensation profile CP(t) (step 950 of FIG. 9). Then, the second device matches the opening degree of the low-pressure EGR control valve 62c to the target opening degree Olplvtgt (step 960 of FIG. 9), and changes the high-pressure EGR control valve 61c according to the target transition Ohplvtgt(t).

Furthermore, the CPU 91 is configured to repeatedly execute the “second compensation-profile-table-correction routine”, which is indicated by the flowchart in FIG. 13, every time a predetermined time period elapses. By this routine, the CPU 91 corrects the compensation profile table MapCP as necessary.

More specifically, the CPU 91 starts a process at step 1300 of FIG. 13 and then proceeds to step 1310 at a predetermined time. At step 1310, the CPU 91 determines whether or not the NOx amount transition NOx(t) during the compensation period of EGR gas amount has already obtained at this moment.

The CPU 91 makes the “No” determination at step 1310 when the NOx amount transition NOx(t) has not yet obtained at this moment (for example, during the compensation period of EGR gas amount). Then, the CPU 91 proceeds to step 1395 so as to end this routine once. Therefore, the compensation profile table MapCP is not corrected when the NOx amount transition NOx(t) has not yet obtained at this moment.

To the contrary, the CPU 91 makes the “Yes” determination at step 1310 when the NOx amount transition NOx(t) has already obtained at this moment to proceed to step 1320.

At step 1320, the CPU 91 obtains the NOx amount difference transition ΔNOx(t) by subtracting the referential NOx amount transition NOxref(t) from the NOx amount transition NOx(t). Therefore, the NOx amount difference transition ΔNOx(t) becomes “positive value” at the timing where the NOx amount transition NOx(t) is larger than the referential NOx amount transition NOxref(t), the NOx amount difference transition ΔNOx(t) becomes “negative value” at the timing where the NOx amount transition NOx(t) is smaller than the referential NOx amount transition NOxref(t).

Next, the CPU 91 proceeds to step 1330. At step 1330, the CPU 91 determines whether or not the opening degree of the low-pressure EGR control valve 62c increases during the compensation period of EGR gas amount.

The CPU 91 makes the “Yes” determination at step 1330 to proceed to step 1340 when the opening degree of the low-pressure EGR control valve 62c increases during the compensation period of EGR gas amount. At step 1340, the CPU 91 determines whether or not the NOx amount difference ΔNOx (adj. t1) is positive at “a timing adj. t1 around the start time of the change (the timing t1)” and the NOx amount difference ΔNOx (adj. t2) is negative at “a timing adj. t2 around the end time of the change (the timing t2)”.

The CPU 91 makes the “Yes” determination at step 1340 to proceed to step 1350 when the NOx amount difference ΔNOx(adj.t1) is positive and the NOx amount difference ΔNOx(adj.t2) is negative. At step 1350, the CPU 91 corrects the compensation profile table MapCP so that the start of increasing the high-pressure EGR gas amount HPL becomes earlier. After that, the CPU 91 proceeds to step 1395 so as to end this routine once.

On the other hand, the CPU 91 makes the “No” determination at step 1340 to proceed to step 1360 when at least one of the NOx amount difference ΔNOx(adj.t1) being positive and the NOx amount difference ΔNOx(adj.t2) being negative is not satisfied. At step 1360, the CPU 91 determines whether or not the NOx amount difference ΔNOx(adj.t1) is negative and the NOx amount difference ΔNOx(adj.t2) is positive.

The CPU 91 makes the “Yes” determination at step 1360 to proceed to step 1370 when the NOx amount difference ΔNOx(adj.t1) is negative and the NOx amount difference ΔNOx(adj.t2) is positive. At step 1370, the CPU 91 corrects the compensation profile table MapCP so that the start of increasing the high-pressure EGR gas amount HPL becomes delayed. After that, the CPU 91 proceeds to step 1395 so as to end this routine once.

In addition, the CPU 91 makes the “No” determination at step 1360 when at least one of the NOx amount difference ΔNOx(adj.t1) is negative and the NOx amount difference ΔNOx(adj.t2) is positive is not satisfied. After that, the CPU 91 proceeds to step 1395 so as to end this routine once. Therefore, the compensation profile table MapCP is not corrected according to the concept of the second device in this case.

To the contrary, the CPU 91 makes the “No” determination at step 1330 to proceed to step 1380 when the opening degree of the low-pressure EGR control valve 62c decreases during the compensation period of EGR gas amount. At step 1380, the CPU 91 determines whether or not the NOx amount difference ΔNOx(adj.t1) is positive and the NOx amount difference ΔNOx(adj.t2) is negative.

The CPU 91 makes the “Yes” determination at step 1380 to proceed to step 1370 when the NOx amount difference ΔNOx(adj.t1) is positive and the NOx amount difference ΔNOx(adj.t2) is negative. At step 1370, the CPU 91 corrects the compensation profile table MapCP so that the start of increasing the high-pressure EGR gas amount HPL becomes delayed. After that, the CPU 91 proceeds to step 1395 so as to end this routine once.

On the other hand, the CPU 91 makes the “No” determination at step 1380 to proceed to step 1390 when at least one of the NOx amount difference ΔNOx(adj.t1) being positive and the NOx amount difference ΔNOx(adj.t2) being negative is not satisfied. At step 1390, the CPU 91 determines whether or not the NOx amount difference ΔNOx(adj.t1) is negative and the NOx amount difference ΔNOx(adj.t2) is positive.

The CPU 91 makes the “Yes” determination at step 1390 to proceed to step 1350 when the NOx amount difference ΔNOx(adj.t1) is negative and the NOx amount difference ΔNOx(adj.t2) is positive. At step 1350, the CPU 91 corrects the compensation profile table MapCP so that the start of increasing the high-pressure EGR gas amount HPL becomes earlier. After that, the CPU 91 proceeds to step 1395 so as to end this routine once.

In addition, the CPU 91 makes the “No” determination at step 1390 when at least one of the NOx amount difference ΔNOx(adj.t1) is negative and the NOx amount difference ΔNOx(adj.t2) is positive is not satisfied. After that, the CPU 91 proceeds to step 1395 so as to end this routine once. Therefore, the compensation profile table MapCP is not corrected according to the concept of the second device in this case.

As described above, the CPU 91 compensates for the deviation DEVIpI of the low-pressure EGR gas amount LPL by increasing or decreasing the high-pressure EGR gas amount HPL based on the compensation profile CP(t). Furthermore, the CPU 91 corrects the compensation profile table MapCP, which is used to determine the compensation profile CP(t), based on the NOx amount difference transition ΔNOx(t) during the compensation period of EGR gas amount. By the above operation, the corrected compensation profile table MapCP can determine the compensation profile CP(t) that is more appropriate in the viewpoint of the compensation for the deviation DEVIpI compared with the table before the correction. As a result thereof, the deviation DEVIpI of the low-pressure EGR gas amount LPL is compensated more surely.

### <General Overview of Second Embodiment>

As described referring to FIG. 4, FIG. 6 and FIG. 11 to FIG. 13, in the control device according to the second embodiment of the invention (the second device), the control pattern MapCP is corrected as necessary based on “the index (NOx) that is a constituent having an amount decreasing with increasing total amount HPL+LPL of the exhaust gas recirculated by the first means 62 and the second means 61 and entered into the combustion chamber”.

More specifically,

(3) In the case that the target amount LPLtgt of the first recirculated gas amount LPL is changed and the first recirculated gas amount LPL is “increased” toward the target amount LPLtgt (for example, see FIG. 11):

The control pattern MapCP is corrected to make a start of increasing the second recirculated gas amount HPL earlier, upon the difference ΔNOx(adj.t1) of the index at first timing around the start time t1 is the “positive value” and the difference ΔNOx(adj.t2) of the index at second timing around the end time t2 is the “negative value”. On the other hand, the control pattern MapCP is corrected to make a start of increasing the second recirculated gas amount HPL delayed, upon the difference ΔNOx(adj.t1) of the index at the first timing being the “negative value” and the difference ΔNOx(adj.t2) of the index at the second timing being the “positive value”.

(4) In the case that the target amount LPLtgt of the first recirculated gas amount LPL is changed and the first recirculated gas amount LPL is “decreased” toward the target amount LPLtgt (for example, see FIG. 12):

The control pattern MapCP is corrected to make a start of decreasing the second recirculated gas amount HPL delayed, upon the difference ΔNOx(adj.t1) of the index at the first timing is the “positive value” and the difference ΔNOx(adj.t2) of the index at the second timing is the “negative value”. On the other hand, the control pattern MapCP is corrected to make a start of decreasing the second recirculated gas amount HPL earlier, upon the difference ΔNOx(adj.t1) of the index at the first timing is the “negative value” and the difference ΔNOx(adj.t2) of the index at the second timing is the “positive value”.

By the way, methods to determine the degree of “the advance of start to increasing or decreasing the second recirculated gas amount” and the degree of “the delay of start to increasing or decreasing the second recirculated gas amount” are not specifically limited. For example, these degrees may be determined based on the length of time where the difference ΔNOx(adj.t1) of the index or the difference ΔNOx(adj.t2) of the index occur. These are the description for the second device.

### <Other Embodiments >

While the invention has been described in detail by referring to the specific embodiments, it is apparent that various modifications or corrections may be made by the person skilled in the art without departing from the spirit and the scope of the invention.

For example, in the control device of the invention, it is preferable that, first response time (that corresponds to the compensation time for EGR gas amount of the first device and the second device) that is a length of time required from a moment t1 of starting the change of the first recirculated gas amount LPL to a moment t2 of entering the exhaust gas having the changed first recirculated gas amount into the combustion chamber, and second response time that is a length of time required from a moment of starting the change of the second recirculated gas amount HPL to a moment of entering the exhaust gas having the changed second recirculated gas amount HPL into the combustion chamber, satisfy the relationship that the second response time is “shorter” than the first response time.

Furthermore, in the first device and the second device, when the low-pressure EGR gas amount LPL is changed toward the target amount LPLtgt, the correction of the deviation DEVIpI by the high-pressure EGR gas amount HPL is carried out regardless of the amount of the change amount. However, the control means may be configured to increase or decrease the second recirculated gas amount HPL according to the control pattern MapCP, “only” upon the “difference ΔNOx between the actual amount of the first recirculated gas amount LPL at the start time and the target amount LPLtgt of the first recirculated gas amount LPL” is larger than a predetermined threshold value.

Additionally, the first device and the second device are applied to diesel engines. However, the control device of the invention may be applied to spark-ignition engines.

1. A control device for internal combustion engine, the engine having,
first member for recirculating exhaust gas discharged from a combustion chamber of the engine to an exhaust passage toward an intake passage through first passage, and
second member for recirculating exhaust gas discharged from the combustion chamber to the exhaust passage toward the intake passage through second passage different from the first passage,
the control device being configured to,
control recirculated gas amount of first recirculated gas amount and second recirculated gas amount, the first recirculated gas amount being an amount of exhaust gas recirculated by the first member and entered into the combustion chamber, the second recirculated gas amount being an amount of exhaust gas recirculated by the second means member and entered into the combustion chamber,
the control device being configured to have a predetermined control pattern to increase or decrease the second recirculated gas amount to compensate for a difference of the first recirculated gas amount with reference to a target amount, and increasing or decreasing the second recirculated gas amount according to the control pattern during a period from a start time of change to an end time of change, the start time being a moment of the first recirculated gas amount being started to change toward the target amount, the end time being a moment of the first recirculated gas amount being reached to the target amount,
the control pattern being corrected to decrease a difference of index related to the recirculated gas amount, upon an actual amount of the index not matching a referential amount thereof while the second recirculated gas amount being increased or decreased according to the control pattern during the period from the start time to the end time, the index being a constituent included in the exhaust gas discharged from a combustion chamber to the exhaust passage, and an amount of the constituent varying depending on total amount of the exhaust gas recirculated by the first member and the second member and entered into the combustion chamber, the difference of the index being a difference of the actual amount with reference to the referential amount.

2. The control device according to claim 1,
the control pattern being corrected based on whether the difference of the index during the period from the start time to the end time being zero, positive value, and negative value.

3. The control device according to claim 1,
the index being a constituent having an amount decreasing with increasing total amount of the exhaust gas recirculated by the first member and the second member and entered into the combustion chamber,
the control pattern being corrected in the following manner, upon the target amount of the first recirculated gas amount being changed and the first recirculated gas amount being increased toward the target amount: to increase an increased amount of the second recirculated gas amount at a moment of occurrence of the difference of the index of a positive value or a moment just before the occurrence thereof, upon the difference of the index being the positive value; or to decrease an increased amount of the second recirculated gas amount at a moment of occurrence of the difference of the index of a negative value or a moment just before the occurrence thereof, upon the difference of the index being the negative value,
the control pattern being corrected in the following manner, upon the target amount of the first recirculated gas amount being changed and the first recirculated gas amount being decreased toward the target amount: to decrease a decreased amount of the second recirculated gas amount at a moment of occurrence of the difference of the index of a positive value or a moment just before the occurrence thereof, upon the difference of the index being the positive value; or to increase a decreased amount of the second recirculated gas amount at a moment of occurrence of the difference of the index of a negative value or a moment just before the occurrence thereof, upon the difference of the index being the negative value.

4. The control device according to claim 1,
the index being a constituent having an amount decreasing with increasing total amount of the exhaust gas recirculated by the first member and the second member and entered into the combustion chamber,
the control pattern being corrected in the following manner, upon the target amount of the first recirculated gas amount being changed and the first recirculated gas amount being increased toward the target amount: to make a start of increasing the second recirculated gas amount earlier, upon the difference of the index at first timing around the start time being the positive value and the difference of the index at second timing around the end time being the negative value; or to make a start of increasing the second recirculated gas amount delayed, upon the difference of the index at the first timing being the negative value and the difference of the index at the second timing being the positive value,
the control pattern being corrected in the following manner, upon the target amount of the first recirculated gas amount being changed and the first recirculated gas amount being decreased toward the target amount: to make a start of decreasing the second recirculated gas amount delayed, upon the difference of the index at the first timing being the positive value and the difference of the index at the second timing being the negative value; or to make a start of decreasing the second recirculated gas amount earlier, upon the difference of the index at the first timing being the negative value and the difference of the index at the second timing being the positive value.

5. The control device according to claim 1,
first response time being a length of time required from a moment of starting the change of the first recirculated gas amount to a moment of entering the exhaust gas having the changed first recirculated gas amount into the combustion chamber,
second response time being a length of time required from a moment of starting the change of the second recirculated gas amount to a moment of entering the exhaust gas having the changed second recirculated gas amount into the combustion chamber,
the second response time being shorter than the first response time.

6. The control device according to claim 1,
the control device being configured to increase or decrease the second recirculated gas amount according to the control pattern, only upon the difference between the actual amount of the first recirculated gas amount at the start time and the target amount of the first recirculated gas amount being larger than a predetermined threshold value.

7. The control device according to claim 1,
the first member having a first control valve to change an amount of exhaust gas passing through the first passage,
the second member having a second control valve to change an amount of exhaust gas passing through the second passage.

8. The control device according to claim 1,
the index being at least one of nitrogen oxide and oxygen included in the exhaust gas discharged from the combustion chamber.
